(19) United States
(12) Patent Application Publication
(10) Pub. No.: US 2024/0385502 A1
(43) Pub. Date: Nov. 21, 2024

(54) LASER PROJECTOR SIMULATION

(71) Applicant: FARO Technologies, Inc., Lake Mary, FL (US)

(72) Inventors: Maxime Thierry Isabelle, Montreal (CA); John Chan, Montreal (CA); Aleksi Sapon, Montreal (CA); Yunhua Wang, Korntal-Muchingen (DE)

(21) Appl. No.: 18/199,650

(22) Filed: May 19, 2023

Related U.S. Application Data
(60) Provisional application No. 63/344,853, filed on May 23, 2022.

(51) Int. Cl. G03B 21/20; G01B 11/00; G06T 7/521

(52) U.S. Cl. CPC G03B 21/2033; G01B 11/002; G06T 7/521; G06T 2207/10028

(57) ABSTRACT

Examples described herein provide a computer-implemented method that includes receiving a point cloud representative of a real-world environment. The method further includes simulating a projection of a laser projector into a virtual environment based at least in part on the point cloud, the virtual environment representative of the real-world environment. The method further includes evaluating the projection to determine whether at least one projector preference is satisfied. The method further includes, responsive to determining that the at least one projector preference is not satisfied, adjusting at least one of a position of the laser projector, an orientation of the laser projector, or a property of the laser projector.

### CROSS-REFERENCE TO RELATED APPLICATIONS

This application claims the benefit of U.S. Provisional Patent Application No. 63/344,853, entitled “LASER PROJECTOR SIMULATION,” filed May 23, 2022, the disclosure of which is incorporated by reference herein in its entirety.

### BACKGROUND

The subject matter disclosed herein relates to a light projection system, often referred to as a “laser projection system” or “laser projector,” and in particular to light projection simulation that simulates a laser projector that projects a glowing light pattern onto an object without using retroreflective or cooperative targets.

Light projection devices are used in a variety of applications to project images onto objects. In some applications, an illuminated three-dimensional (3D) pattern, also referred to as a “template,” is projected onto an object. The template may be formed, for example, by projecting a rapidly moving, vector-scan, light beam onto the object. In some systems, the projected light beam is a laser beam. The light beam strikes the surface of the object following a predetermined trajectory in a repetitive manner. When repetitively moved at a sufficiently high beam speed and refresh rate, the trace of the projected beam on the object appears to the human eye as a continuous glowing line. The projected pattern of light appears as the glowing template that can be used to assist in the positioning of parts, components and work pieces. In some cases, the projected template is based partly on computer aided design (CAD) data of the object.

A challenge faced by light projection devices is in aligning the light projection system to the environment in which it is located so that the template is positioned in the desired location and orientation. Accordingly, while existing systems and methods of patterned light projection are suitable for their intended purposes, the need for improvement remains, particularly in providing simulation of a light projection system having the features described herein.

### BRIEF DESCRIPTION

In one exemplary embodiment, a computer-implemented method is provided. The method includes receiving a point cloud representative of a real-world environment. The method further includes simulating a projection of a laser projector into a virtual environment based at least in part on the point cloud, the virtual environment representative of the real-world environment. The method further includes evaluating the projection to determine whether at least one projector preference is satisfied. The method further includes, responsive to determining that the at least one projector preference is not satisfied, adjusting at least one of a position of the laser projector, an orientation of the laser projector, or a property of the laser projector.

In addition to one or more of the features described herein, or as an alternative, further embodiments of the method may include that receiving the point cloud representative of the real-world environment includes scanning the real-world environment with a laser scanner to obtain a plurality of three-dimensional coordinates in the real-world environment.

In addition to one or more of the features described herein, or as an alternative, further embodiments of the method may include that the at least one projector preference includes a field of view preference.

In addition to one or more of the features described herein, or as an alternative, further embodiments of the method may include that the at least one projector preference includes an overlap preference.

In addition to one or more of the features described herein, or as an alternative, further embodiments of the method may include that the at least one projector preference includes an incident angle preference.

In addition to one or more of the features described herein, or as an alternative, further embodiments of the method may include that the at least one projector preference includes an obstruction preference.

In addition to one or more of the features described herein, or as an alternative, further embodiments of the method may include that the laser projector is a first laser projector, and wherein simulating the projection includes simulating the projection for the first laser projector and a second laser projector.

In addition to one or more of the features described herein, or as an alternative, further embodiments of the method may include, subsequent to adjusting the at least one of the position or the orientation of the laser projector: re-simulating the projection of the laser projector into the virtual environment that is based at least in part on the point cloud; and re-evaluating the projection to determine whether the at least one projector preference is satisfied.

In addition to one or more of the features described herein, or as an alternative, further embodiments of the method may include, prior to simulating the projection, aligning the point cloud to the real-world environment.

In addition to one or more of the features described herein, or as an alternative, further embodiments of the method may include disposing the laser projector in the real-world environment based at least in part on the simulation.

In another exemplary embodiment a system includes a memory including computer readable instructions and a processing device for executing the computer readable instructions. The computer readable instructions control the processing device to perform operations. The operations include receiving a point cloud representative of a real-world environment. The operations further include simulating a projection of a laser projector into a virtual environment based at least in part on the point cloud, the virtual environment representative of the real-world environment. The operations further include evaluating the projection to determine whether at least one projector preference is satisfied. The operations further include, responsive to determining that the at least one projector preference is not satisfied, adjusting at least one of a position of the laser projector, an orientation of the laser projector, or a property of the laser projector.

In addition to one or more of the features described herein, or as an alternative, further embodiments of the system may include that receiving the point cloud representative of the real-world environment includes scanning the real-world environment with a laser scanner to obtain a plurality of three-dimensional coordinates in the real-world environment.

In addition to one or more of the features described herein, or as an alternative, further embodiments of the system may include that the at least one projector preference includes a field of view preference.

In addition to one or more of the features described herein, or as an alternative, further embodiments of the system may include that the at least one projector preference includes an overlap preference.

In addition to one or more of the features described herein, or as an alternative, further embodiments of the system may include that the at least one projector preference includes an incident angle preference.

In addition to one or more of the features described herein, or as an alternative, further embodiments of the system may include that the at least one projector preference includes an obstruction preference.

In addition to one or more of the features described herein, or as an alternative, further embodiments of the system may include that the laser projector is a first laser projector, and wherein simulating the projection includes simulating the projection for the first laser projector and a second laser projector.

In addition to one or more of the features described herein, or as an alternative, further embodiments of the system may include that the operations further include, subsequent to adjusting the at least one of the position or the orientation of the laser projector: re-simulating the projection of the laser projector into the virtual environment that is based at least in part on the point cloud; and re-evaluating the projection to determine whether the at least one projector preference is satisfied.

In addition to one or more of the features described herein, or as an alternative, further embodiments of the system may include that the operations further include, prior to simulating the projection, aligning the point cloud to the real-world environment.

In addition to one or more of the features described herein, or as an alternative, further embodiments of the system may include that the operations further include disposing the laser projector in the real-world environment based at least in part on the simulation.

The above features and advantages, and other features and advantages, of the disclosure are readily apparent from the following detailed description when taken in connection with the accompanying drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIGS. 1A, 1B, and 1C are perspective, front, and bottom views, respectively, of a light projector according to an embodiment;

FIG. 1D is a perspective view of the light projector in accordance with another embodiment;

FIGS. 2A, 2B, and 2C are perspective, top, and side views, respectively, of optical and electro-optical elements of the light projector according to an embodiment;

FIG. 2D is a cross-sectional view of an optical and electro-optical elements of the light projector according to an embodiment;

FIG. 3 is a perspective view of electrical components within the light projector according to an embodiment;

FIG. 4 is an electrical block diagram of the light projector according to an embodiment;

FIG. 5A is a diagram illustrating a path of the laser beam emitted from the system of FIG. 1 forming a scan pattern in accordance with an embodiment;

FIG. 5B is a diagram illustrating another path of the laser beam emitted from the light projector of FIG. 1 forming a scan pattern in accordance with an embodiment;

FIG. 6 is a flow diagram illustrating a method of aligning the light projector of FIG. 1 in accordance with an embodiment;

FIG. 7 is a flow diagram illustrating a method of checking for drift and realigning the laser projector of FIG. 1 in accordance with an embodiment;

FIG. 8 is a flow diagram illustrating a method of changing an orientation of the light projector of FIG. 1 and realigning the light projector to the environment in accordance with an embodiment;

FIG. 9 is a flow diagram illustrating a method of aligning the light projector of FIG. 1 and emitting a topography line on a surface in accordance with an embodiment;

FIG. 10 is a flow diagram illustrating a method of aligning the light projector of FIG. 1 using photo stitching;

FIG. 11 is a perspective view of a laser scanner according to one or more embodiments described herein;

FIG. 12 is a side view of the laser scanner illustrating a method of measurement according to one or more embodiments described herein;

FIG. 13 is a schematic illustration of the optical, mechanical, and electrical components of the laser scanner according to one or more embodiments described herein;

FIG. 14 is a schematic illustration of the laser scanner of FIG. 11 according to one or more embodiments described herein;

FIG. 15 depicts a system for simulating one or more laser projectors in a virtual environment according to one or more embodiments described herein;

FIGS. 16A-16I depict example interfaces of a simulation performed by the simulation engine of FIG. 15 according to one or more embodiments described herein;

FIG. 17 depicts a flow diagram of a method 1700 for simulating one or more laser projectors in a virtual environment according to one or more embodiments described herein; and

FIG. 18 depicts a block diagram of a processing system for implementing the techniques described herein.

The detailed description explains embodiments of the disclosure, together with advantages and features, by way of example with reference to the drawings.

### DETAILED DESCRIPTION

Embodiments described herein provide for laser projector simulation. Particularly, one or more embodiments relate to simulating one or more laser projectors in a virtual environment to evaluate the projection of the one or more laser projectors to enable the position/orientation of the one or more laser projectors to be adjusted. For example, one or more projector preferences are evaluated to determine whether the position/orientation of the one or more laser projectors is satisfactory. Examples of projector preferences include field of view preference, overlap preference, incident angle preference, obstruction preference, etc. For example, if a projection of one or more of the laser projections is obstructed, the projector preference is considered unsatisfactory, and the position/orientation of the one or more laser projector may be adjusted to reduce the obstruction. One or more embodiments described herein utilize a point cloud of a real-world environment to perform the simulation.

Conventional approaches for evaluating laser projection often use computer aided design (CAD) data to perform simulations. However, CAD data is generally design-based data and may not accurately reflect as-built conditions of the real-world environment. Moreover, many times, CAD data about a real-world environment is unavailable.

The present techniques for simulating a projection of one or more projectors provides improved simulation because point cloud data (e.g., data captured by a three-dimensional scanner) of a real-world environment is used in the simulation. The point cloud data provides a more accurate representation of the real-world environment than CAD data. Moreover, the projection is more accurate because the point cloud data accurately represents the real-world environment (e.g. as-built) where CAD data may differ from the actual environment.

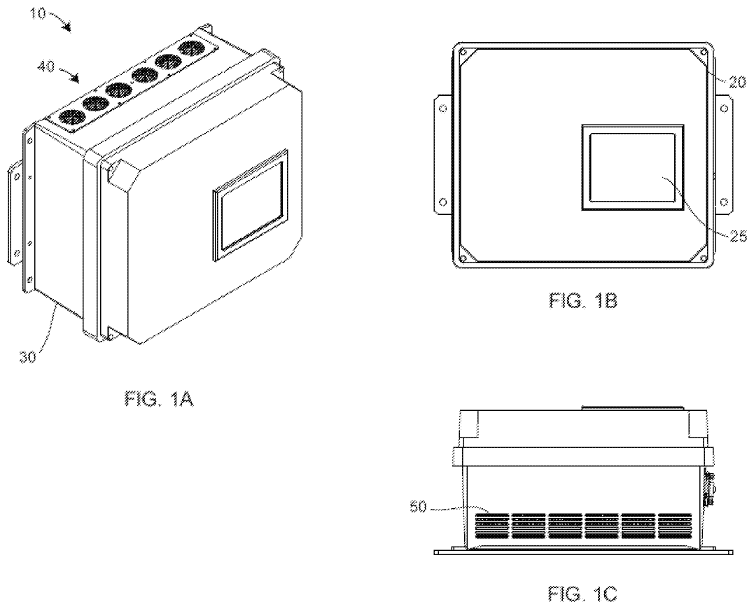

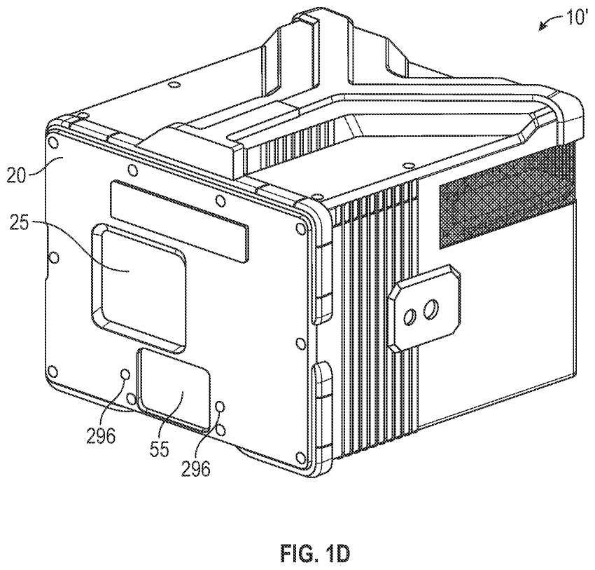

One or more embodiments of a light projector to be simulated are now described with reference to FIGS. 1A-10.

FIGS. 1A, 1B, 1C are perspective, front, and bottom views of a light projector 10 (also referred to as a “laser projector”) according to an embodiment. In an embodiment, the light projector 10 includes a front cover 20, a window 25, a base housing 30, a fan assembly 40, and venting slots 50. In an embodiment, a beam of light is sent out of and returned back through the window 25. In another embodiment, the light projector 10′ may include a second window 55. As described in more detail herein, a the light projector 10′ includes one or more two-dimensional or three-dimensional (e.g. RGB-D) cameras. In an embodiment, the cameras acquire images through the second window 55.

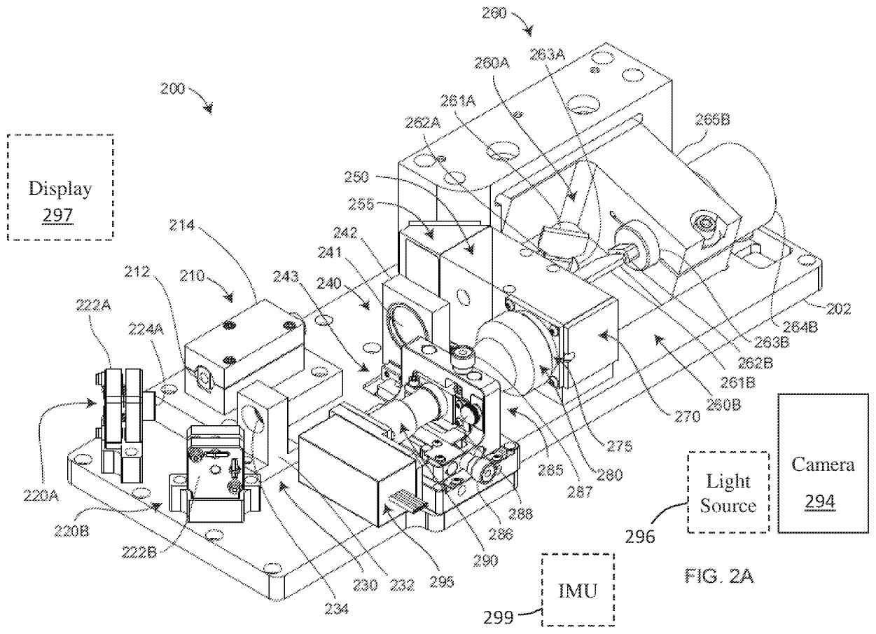

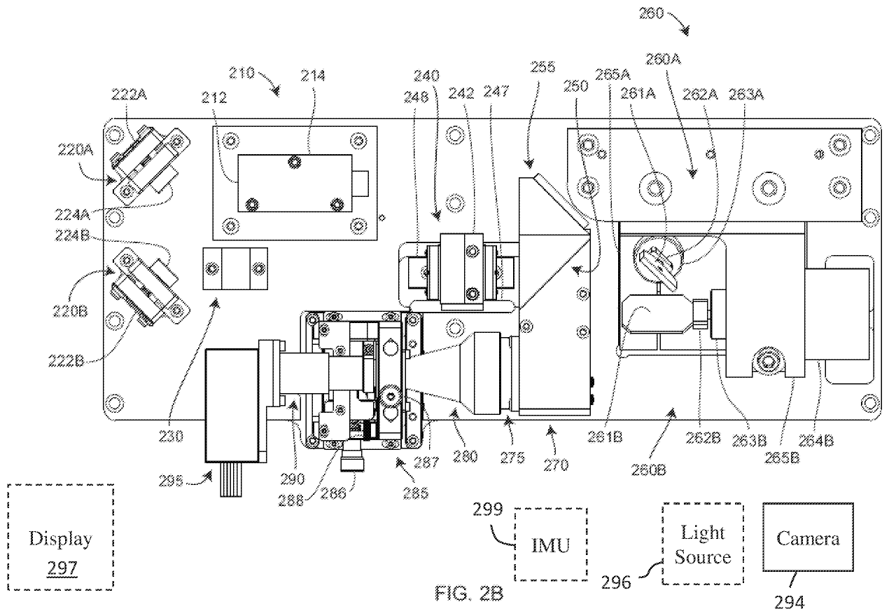

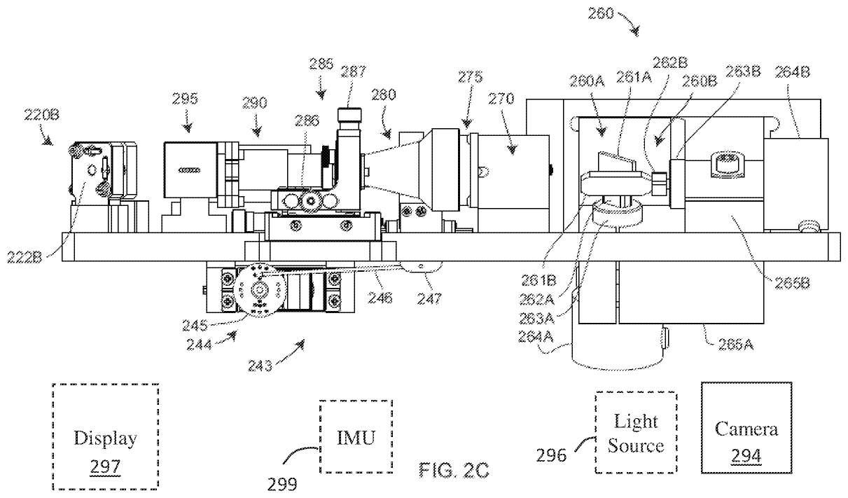

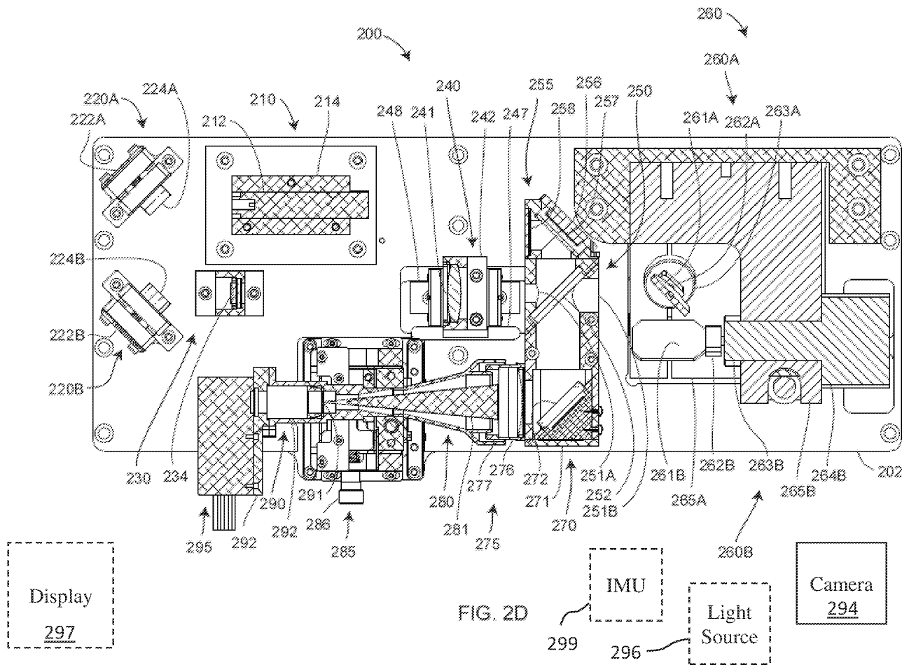

FIGS. 2A, 2B, 2C, 2D are perspective, top, side, and cross-sectional views, respectively, of an electro-optical plate assembly 200 within the light projector 10. In an embodiment, the light projector 10 includes a mounting plate 202, a light source assembly 210, fold mirror assemblies, 220A, 220B, expanding lens assembly 230, collimating/focusing lens assembly 240, beamsplitter assembly 250, two-axis beam-steering assembly 260, reflector mirror assembly 270, focusing lens assembly 275,

In an embodiment, the light source assembly 210 includes a light source 212 and a mounting block 214. In an embodiment, the light source 212 is a diode-pumped solid state laser (DPSS) that emits a round beam of green laser light having a wavelength of about 532 nm. In other embodiments, the light source 212 is a different type of laser such as a diode laser or is a non-laser source. In an embodiment, the fold mirror assemblies 220A. 220B include fold mirrors 224A, 224B, respectively, and adjustable mirror mounts 222A, 222B, respectively. In an embodiment, light from the light source reflects off the fold mirrors 224A, 224B and then travels through a beam expander 230, which includes a beam expander lens 234 and a beam expander mount 232. The expanded beam of light from the beam expander 230 travels through a collimating/focusing lens assembly 240, which acts to focus the beam leaving the light projector 10 onto an object of interest. Because the light leaving the light projector 10 is relatively far from the light projector 10, the beam of light is nearly collimated and converges relatively slowly to a focused spot. In an embodiment, the collimating/focusing lens assembly 240 includes a lens 241, a lens mount 242, and a motorized focusing stage 243. The motorized focusing stage 243 adjusts the position of the lens 241 and lens mount 242 to focus the beam of light onto the object of interest. In an embodiment, the motorized focusing stage 243 includes a servomotor assembly 244 that drives a rotary actuator 245 attached to shaft 246 affixed to an attachment 247. As the rotary actuator 245 rotates, it causes the lens mount 242 to be translated on a ball slide 248.

In an embodiment, the beamsplitter assembly 250 includes entrance aperture 251A, exit aperture 251B, and beamsplitter 252. In an embodiment, the beamsplitter 252 is a 50/50 beamsplitter, which is to say that the beamsplitter 252 transmits half and reflects half the incident optical power. Half of the light arriving at the beamsplitter assembly 250 from the collimating/focusing lens assembly 240 is reflected onto a beam absorber assembly 255, which absorbs almost all the light, thereby preventing unwanted reflected light from passing back into the electro-optical plate assembly 200. In an embodiment, the beam absorber assembly 255 includes a neutral density filter 256, a felt absorber 257, and a felt absorber 258.

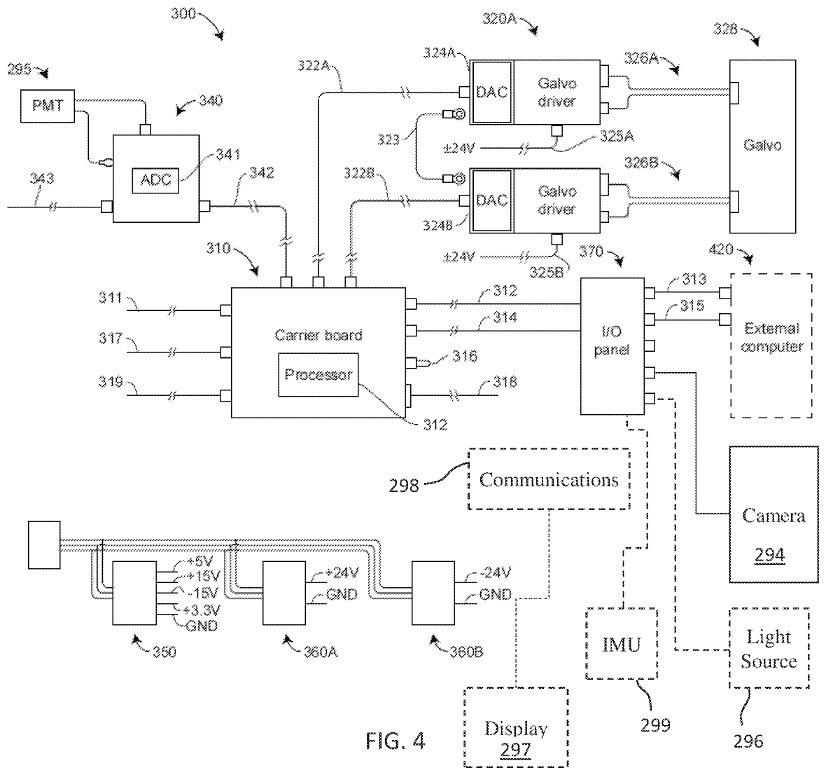

The two-axis beam-steering assembly 260 includes beam steering assemblies 260A, 260B. Each beam steering assembly 260A, 260B includes respectively a light weight mirror 261A, 261B, a mirror mount 262A, 262B, a motor 263A, 263B, a position detector 264A, 264B, and a mounting block 265A, 265B. The first mirror 261A steers the beam of light to the second mirror 261B, which steers the beam out of the window 25 to the object of interest. The beam-steering assembly 260 steers the beam in each of two orthogonal axes, sometimes referred to as x-y axes. In an embodiment, the beam-steering assembly 260 is provided steering directions to move the beam of light in a predetermined pattern by a processor 312 (FIG. 4). Light reflected or scattered off the object of interest retraces the outgoing path, striking first the mirror 261B and then the mirror 261A before passing through the exit aperture 251B, and reflecting off the beamsplitter 252. Beam steering assemblies such as 260A, 260B are also each referred to as galvanometers or galvos, which is an electromechanical device that works as an actuator that produces a rotary deflection, in this case of the mirrors 261A, 261B.

The mirror assembly 270 includes mount 271 and return mirror 272. The focusing mirror assembly 275 includes focusing lens 276 and lens mount 277. In an embodiment, light arriving at the return mirror 272 from the beamsplitter 252 passes through the focusing lens 276. In an embodiment, the focusing lens 276 is a doublet. In an embodiment, an opaque cone 280 smoothly slides over lens mount 277 and attaches rigidly to adjustment stage 285. The purpose of the opaque cone 280 is to block background light from within the light projector 10 from contaminating the light emitted by the light source 210 and reflected off the object of interest and passing through the lens 276. Aperture assembly includes aperture 291 and aperture mount 292. In an embodiment, the aperture assembly 290 is rigidly affixed to the optical detector assembly 295 by an interface element 292. In an embodiment, the aperture assembly 290 is further rigidly coupled to the adjustment stage 285. The adjustment stage 285 is adjusted in the x direction by an x adjuster 286, in the y direction by a y adjuster 287, and in the z direction by a z adjuster 288. The purpose of the adjustment stage 285 is to adjust the position of the aperture 291 and the optical detector assembly 295 in x, y, and z relative to the beam of light to enable the focused beam of light 281 to pass through the aperture for the object of interest located within the rated range of distances of the object being scanned with the light from the light projector 10. The purpose of the aperture is to block unwanted background light, especially light scattered from within the enclosure of the laser projector 10, for example, off the mirrors 216A, 216B, the beamsplitter 252, the components of the beam block 255, the return mirror 272, and the focusing lens 276. In addition, the aperture 291 helps to block unwanted background light from the environment outside the enclosure of the light projector 10. Examples of such unwanted background light blocked by the aperture include artificial light and sunlight, both direct and reflected.

In an embodiment, the aperture 291 is a circular aperture. In an embodiment, the circular aperture has a diameter of 150 micrometers and a centering accuracy of +/−20 micrometers. A circular aperture is often referred to as a pinhole, and the element 291 may alternatively be referred to as an aperture or a pinhole. In other embodiments, the aperture is not circular but has another shape.

The optical detector assembly 295 receives light on an optical detector within the assembly 295 and produces an electrical signal in response. In an embodiment, the optical detector is a photomultiplier tube (PMT). In an embodiment, the PMT is includes a high-voltage supply circuit and a low-noise amplifier. In an embodiment, the amplifier is connected close to the PMT anode output pin to reduce the effect of external noise on the produced electrical signal. In an embodiment, the PMT is a Hamamatsu H11903 photosensor manufactured by Hamamatsu Photonics K.K., with headquarters in Shimokanzo, Japan. An advantage of a PMT for the present application includes high sensitivity to small optical powers and ability to measure both very weak optical signals and very strong optical signals. In an embodiment, the gain of the PMT can be adjusted by a factor of 100,000 or more according to the selected gain level, which is determined by the voltage applied to the PMT. This wide range of achievable gains enables the light projector to measure object regions ranging from dark black to bright white or shiny (i.e. highly reflective).

As explained herein above, the motorized focusing stage 243 adjusts the position of the lens 241 and lens mount 242 to focus the beam of light from the light projector 10 onto the object of interest. In an embodiment, the motorized focusing stage 243 adjusts the position of the collimating/focusing lens assembly 240 to each of several positions, thereby producing scanning lines of different widths. In an embodiment, the desired focusing of the collimating/focusing lens assembly 240 is found by stepping the lens 241 to each of several positions. At each of those positions, the galvo mirrors 261A, 261B are used to steer the projected light along a line. Without being bound to a particular theory, it is believed the reason for this change in relative optical power level is speckle, which is an effect in which laser light scattered off different portions of an object interfere constructively or destructively to produce the fluctuations in returned optical power. When a laser beam is focused, the relative change in the returned optical power is increased as the beam is swept along the object. In an embodiment, the motorized focusing stage 243 is adjusted until the maximum change in relative optical power is achieved in scanning a line. This ensures that the lens 241 has been adjusted to the position of optimal focus.

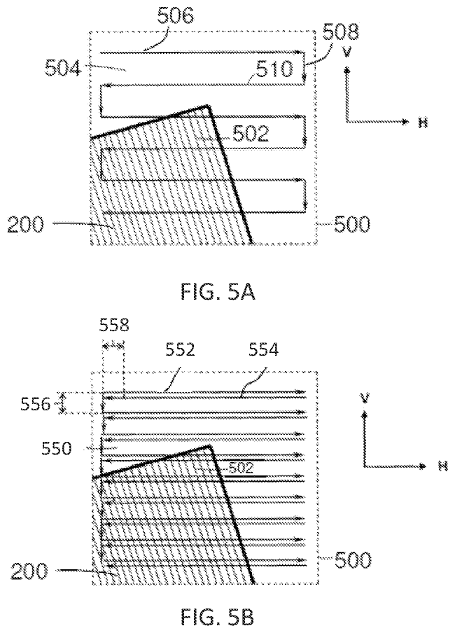

In an embodiment, a pre-scan is performed to determine the desired level of gain for a given scan region (FIG. 5A). For example, if a region is scanned with some elements in the region having a relatively high reflectance, for example because the elements are white, the gain of the PMT is set to a relatively low value since the optical power returned to the PMT is relatively high. On the other hand, if scanning is performed on a region containing only elements having relatively low reflectance, for example because the elements are black or dark, the gain of the PMT is set to a relatively high value. In an embodiment, a pre-scan is performed on a region to be measured as a way to obtain relatively high measurement sensitivity without saturating the PMT. In other words, the use of a pre-scan enables relatively dark objects to be measured even at relatively large distances from the light projector 10. When a region includes both white or light objects as well as black or dark objects, in an embodiment, the region may be broken into sub-regions, with separate scans performed for at least some of the sub-regions.

In an embodiment shown in FIG. 5A, the light projector 10′ performs an initial scan of an area 500 around an object or surface 502 in the environment. The light beam is steered via galvanometers 260A, 260B and mirrors 261A, 261B at a constant velocity and varying azimuth angle H along a pattern 504. The pattern 504 begins along trace line 506. At the end of line 506, the mirror 261A stops and the mirror 261B steers the beam to vary the elevation of the signal light beam along line 508. The mirror 261B then stops and the mirror 261A steers the signal light beam along retrace line 510. This scan process continues in this bi-directional manner to cover the area 500. It should be appreciated that during each trace and retrace, the galvanometer 403 is driven by a stream of digital command signals from processor 312 via a galvo driver 301A, 320B. In an embodiment, the command signals are transmitted at substantially equal time increments as defined by the master clock. At each time increment, processor 312 processes the output of an ADC to determine the pulse amplitude for the object feedback signal that corresponds to the feedback light intensity. In an embodiment, the processor 312 constructs a two-dimensional image array comprised of a series of rows. Each row representing a digitized signal intensity along the trace or retrace line.

In an embodiment, after the completion of the preliminary scan, the processor 312 analyzes a captured digital intensity image (based at least in part of the image array) and determines the high or maximum value of the image array. That value corresponds to a large or maximum amplitude of the amplified feedback signal pulses. Based on the result, the processor may determine adequate levels of controls for that could be used for the next detailed object scan to keep the pulse signals amplitudes within an acceptable signal range for the photodetector assembly 295. It should be appreciated that multiple successive preliminary scans could be performed to establish proper levels of controls for the photodetector assembly 295.

The detailed object/surface scan that is being performed after one or more preliminary scans is illustrated in FIG. 5B. It shows a scan trajectory that follows a bi-directional scan pattern 550. In contrast to the preliminary scan, in an embodiment, the final scan includes a trace 552 and a retrace 554 that are superimposed or collinear. It should be appreciated that lines 552, 554 are illustrated slightly separated in FIG. 5B for clarity purposes only. The processor 312 then proceeds to perform the scan line by line, as described herein with respect to the preliminary scan, with the trace and retrace lines being separated by a vertical segment 556. In an embodiment, the trace and retrace line segment 556 (V pixel size) and the sampling interval 558 (H pixel size) are each typically between 30 to 50 micro radians. In an embodiment, the resolution is user definable.

In an embodiment, an array of pixel data is being constructed by the processor 312 as the result of the detailed object scan. Each element of the array is associated with the H and V pixel locations and contains the values of the feedback light intensity and the time-of-flight represented as the time delay between the reference signal pulse and the feedback signal pulse. The light intensity values are utilized to construct a pixelized two-dimensional intensity image for object feature detection. This feature detection may be the same as that described in U.S. Pat. No. 8,582,087, the contents of which are incorporated herein by reference. The time-of-flight represented as the time delay is used to calculate the distance between the system 10′ and the pixel point by multiplying the value of time delay by the speed of light in air. The time delay is determined as being the difference between the timing locations of the reference signal waveform and the feedback signal waveform with respect to the train of sampling pulses generated by sampling clock. An exemplary method of extracting the timing location of the pulse waveform independently from the pulse's amplitude is described in Merrill Scolnik, “Introduction to Radar Systems”, McGraw-Hill, International Editions, 2002, the contents of which are incorporated herein by reference.

In an embodiment, the light from the light source 212 that leaves the light projector 10′ travels to the object of interest and scatters off the object in a solid angle, afterwards retracing its path as it returns to the light projector 10′. After reflecting off the mirrors 261B, 261A, the solid angle of returning scattered light is limited in size by the exit aperture 251B. The light then reflects off beamsplitter 252 before passing through the lens 276 to form the focused light beam 281. The direction of focused light beam 281 is determined by the path from a first point at which light from the light projector 10 strikes the object to a second point through the center of the entrance pupil of the lens 276. In an embodiment, the aperture 291 is further aligned to the path that extends from the first point to the second point and into the optical detector assembly 295. Furthermore, in an embodiment, the position of the aperture 291 as adjusted in the z direction to cause the beam waist of the returning beam of light to pass through the aperture 291 when the object is in the range of 5 to 7 meters from the light projector 10. In an embodiment, the aperture 291 is large enough to pass nearly all of the return light through the exit aperture 251B onto the active area of the optical detector at the range of 5 to 7 meters. In an embodiment, the light begins to clip slightly at larger distances such as 10 to 15 meters from the light projector 10′. At distances closer to the light projector 10 than 5 meters, the light may clip more significantly, but this is not usually a problem because the optical power scattered off an object point closer than 5 meters has larger scattered intensity than light scattered off an object point farther from the light projector 10′.

In an embodiment, the aperture 291 is rigidly affixed to the aperture assembly 290, which in turn is rigidly affixed to the optical detector assembly 295. In an embodiment, the optical detector assembly 295 and aperture assembly 290 are further aligned to ensure that returning light passing through the center of the entrance pupil of the lens 276 not only passes through the center of aperture 291 but also the center of the active area of the optical detector in the optical detector assembly 295. As a result, the range of operation of the light projector 10 is made as large as possible. This is to say that the rigid attachment of the aperture 291 to the photodetector assembly 295 in combination with alignment of the aperture 291, the photodetector assembly 295, the lens 276, and the exit aperture 251B helps to ensure that the best sensitivity is obtained for objects both near to and far from the light projector 10′. With this alignment, the pre-scan is also expected to give consistent results in determining the PMT gain settings required for each combination of object distance and object reflectance.

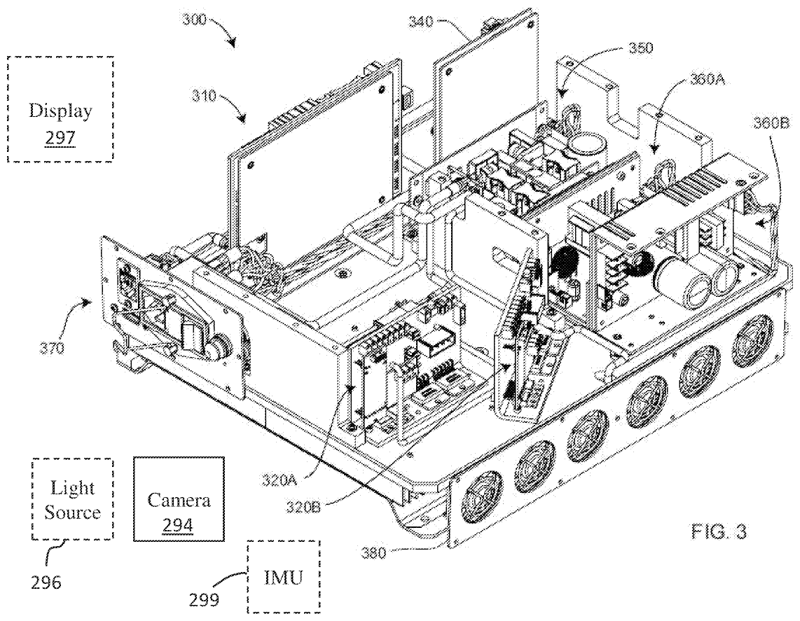

FIG. 3 is a perspective view of the electrical assembly 300 within the light projector 10′, and FIG. 4 is an electrical block diagram for the light projector 10′. The electrical assembly 300 includes an electronics plate 302 and a number of circuit boards including a carrier board 310, first galvo driver 320A, second galvo driver 320B, analog circuit board 340, multi-voltage power supply 350, +24 volt power supply 360A, and −24 volt power supply 360B. The circuit block diagram representation for the electrical assembly 300 is shown in FIG. 4. The carrier board 310 includes a processor 312 that controls many functions within the light projector 10. Control cables 322A, 322B run from the carrier board 310 to digital-to-analog converters (DACs) 324A, 324B on the first and second galvo driver boards 320A, 320B, respectively. Control signals sent from the carrier board 310 to the DACs 324A, 324B control the angles of the mirrors 261A, 261B, thereby controlling the direction to which the beam is steered. Power supplies 360A, 360B supply +24 volts, −24 volts, respectively, to the galvo drivers 320A, 320B, which in turn supply voltages to the galvo motor/position-sensing components 328 through cables 326A, 326B. In an embodiment, a jumper cable 323 is used to connect the first and second galvo driver boards 320A, 320B when synchronized steering is needed in two dimensions (such as X and Y directions).

The analog circuit board 340 includes an analog-to-digital converter (ADC) 341. The ADC 341 receives an analog electrical signals from the optical detector 295, which in an embodiment is a PMT. The ADC 341 converts the analog signals into digital electrical signals, which it sends over an Ethernet cable 342 to the carrier board 310. The carrier board provides the digital data to the processor 312 and, in an embodiment, to an external computer attached to input/output (I/O) panel 370 through a USB cables 313, 314, an Ethernet cable 315, 316, and/or a wireless channel. In an embodiment, the processor 312 or external computer 420 constructs a gray-scale image of the optical powers received by optical detector 295. This image is sometimes referred to as an intensity image, which is different from a photographic image acquired by the camera 294. Such an image may be displayed to a user, may be used to identify features in the scanned object, and may be used for other functions such as setting the position of the focusing lens 241 with the motorized focusing stage 243. In an embodiment, the analog circuit board 340 receives voltages over the cable 343 from the multi-voltage power supply 350. In an embodiment, the carrier board 310 further provides control signals to the motorized focusing stage 243 over the cable 317 and control signals to the light source 212 over the cable 318. A connector 316 is attached to the circuit board to override the laser bypass circuit. In an embodiment, the carrier board 310 is further provided with a cable 319 operable to send a signal to reset the software on the carrier board. The carrier board 310 receives voltages over the cable 311 from the multi-voltage power supply 350. In an embodiment, additional voltages are provided from the multi-voltage power supply 350 to the I/O panel 370 and to the fan assembly 380.

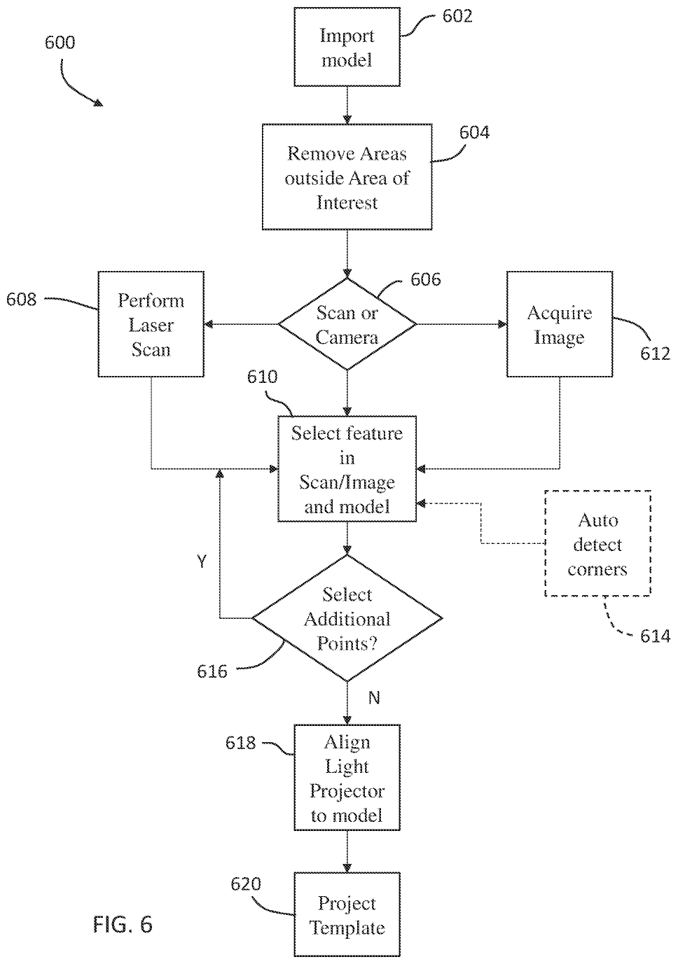

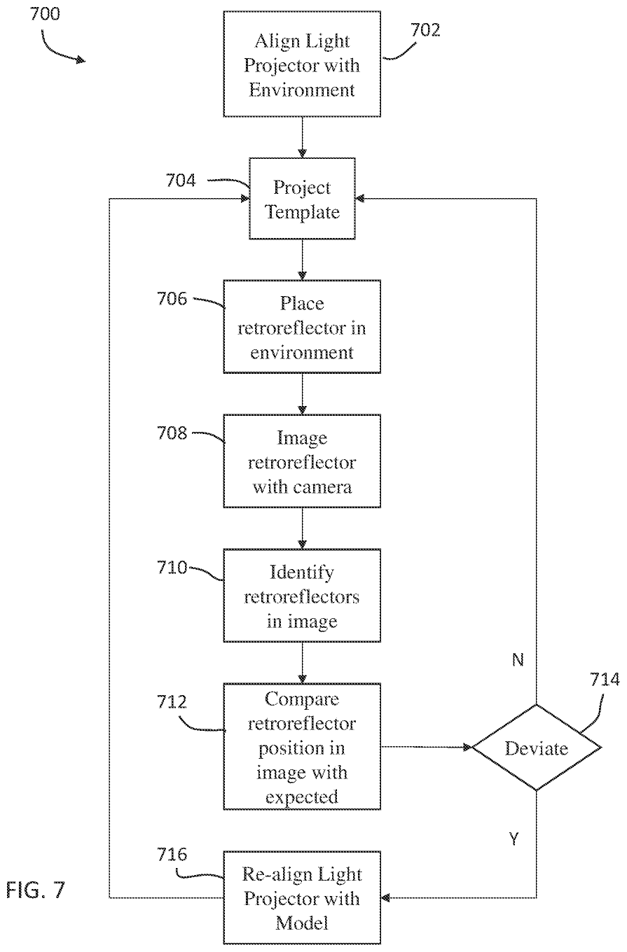

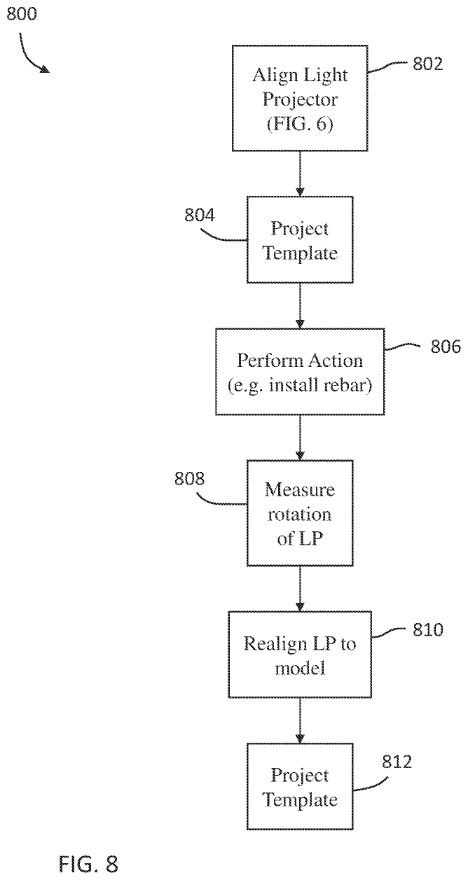

In an embodiment, the light projector further includes a 2D camera 294 and a light source 296. As discussed in more detail herein with reference to FIGS. 6-9, the camera 294 includes a photosensitive array, a shutter, an aperture and one or more lens that may be used to acquire a photographic image of the environment within the field of view of the camera 294 via the window 55. In one or more embodiments, the camera 294 is operably coupled to a display 297 that includes a user interface that is operable to display the acquired image and allow interaction with the operator. In an embodiment, the display 297 may be integral with the housing 30 and acquire images via the second window 55. In another embodiment, the display 297 may be remote from the light projector 10′. The display 297 may be coupled to the camera 294 and/or the processor 312 via wired (e.g. Universal Serial Bus or Ethernet) or via a wireless (e.g. IEEE 802.11. WiFi, or Bluetooth™) communications mediums. In an embodiment, the light projector 10′ may include a communications module 298 (FIG. 4) that is configured to transmit and receive signals from the processor 312, the camera 294, the display 297, and/or one or more remotely located computers. In an embodiment, the display 297 is a mobile computing device, such as a laptop or a tablet computer that is coupled for communication with the light projector 10′ via the communications module 298.

In an embodiment, the communications module may include a IEEE 802.11 (i.e. WiFi) compatible transceiver. The transceiver is configured to emit a signal in the IEEE 802.11 spectrum upon startup of the light projector 10. In this embodiment, the display 297 (or the computing device to which it is attached) may detect the signal and establish communications in accordance with the IEEE 802.11 protocol directly with the light projector 10. It should be appreciated that this provides advantages in environments where there may be no IEEE 802.11 infrastructure or network in place.

In embodiments where the environment where the light projector 10 is to be used has an IEEE 802.11 network available, the display 297 (or the computing device to which it is attached) may connect to the light projector 10 via the network. In an embodiment, the communications module 298 includes an IEEE 802.3 (i.e. Ethernet) communications port. The light projector 10 connects to the IEEE 802.3 network and the display 297 connects to the IEEE 802.11 network. The network created by the IEEE 802.3 and IEEE 802.11 networks provides a communication path between the display 297 and the light projector 10. It should be appreciated that this provides advantages in allowing for a remote connection (e.g. the display 298 is remote from the light projector) or in connecting the display 297 to multiple light projectors 10. In an embodiment, both the light projector 10 and the display 297 connect for communication via the IEEE 802.11 network.

In an embodiment, the light source 296 may include a plurality of light emitting elements (FIG. 1D), such as light emitting diodes (LED's). The LED's 296 may be positioned on the front cover 20 about the window 55. In an embodiment, the LED's 296 are activated to illuminate the environment when the camera 294 acquires an image.

In an embodiment, the light projector 10′ may further include an inertial measurement unit 299 (IMU) that includes sensors, such as accelerometers, compasses, or gyroscopes for example, that allow for an estimation of translational and rotational movement of the light projector 10′. As discussed in more detail herein, the IMU 299 provides additional information that in some embodiments may be used to align the light projector 10′ with an electronic model.

In an embodiment, the light projector 10′ may be the same as that described in commonly owned and concurrently filed United States Provisional Application entitled “Laser Projector” (Attorney Docket Number: FAO0943US), the contents of which are incorporated by reference herein.

It should be appreciated that in order for the image or template to be projected in the desired location, and in the desired pose, the position and orientation/pose of the light projector 10′ in the environment needs to be registered to the model of the environment (e.g. CAD model, As-built CAD model, point cloud). In this way, the processor 312 can determine the vectors for emitting light along a path on a surface in the environment to form the image or template.

Referring now to FIG. 6, an embodiment of a method 600 is shown for registering or aligning the light projector 10′ to the electronic model of the environment. The method 600 begins in block 602 where the electronic model is imported. In the illustrated embodiment, the electronic model is imported into, or is available to the processor 312. In other embodiments, the electronic model may be imported into a computing device remote from the light projector 10′. In still other embodiments, the electronic model is imported into the computing device associated with display 297.

The method 600 then proceeds to block 604 where an optional step is provided for removing portions of the electronic model that are not relevant to the area where the template is to be projected. It should be appreciated that an electronic model, such as a CAD model of a building for example, will have more data than the area where the template is to be projected. In some embodiments, the operator may clip, trim, or delete portions of the electronic model. In some embodiments, by removing portions of the electronic model, the performance of the computing device may be improved.

The method 600 then proceeds to query block 606 where the operator decides whether to register or align the light projector 10′ using an intensity image or a photographic image. When the query block 606 returns a scan election, indicating that the operator wants to use the intensity image, the method 600 proceeds to block 608 where the light projector 10′ performs a scan over its field of view (e.g. FIG. 5B) as described herein. In an embodiment, the operator may activate the camera 294 to display in a viewfinder window on display 297 an image of the area in front of the camera 294. By using the viewfinder, the operator can move, rotate, or change the orientation of the light projector 10′ to generally be oriented towards the area where the template is to be projected. Once the scan is completed, the intensity image is displayed on the display 297 and the method 600 proceeds to block 610.

When the query block 606 returns a camera election, indicating that the operator wants to use a photographic image, the method 600 proceeds to block 612 where an image is acquired using the camera 294. It should be appreciated that the operator may activate the camera 294 and use the viewfinder window to position and orient the light projector 10′ towards the desired area as described above. It should be appreciated that the acquisition of the photographic image is faster than performing the scan to generate the intensity image. In some embodiments, the light projector 10′ may activate the light source 296 to illuminate the environment when the photographic image is acquired. In some embodiments, the operator may place reflective targets or contrast targets (e.g. black and white checkerboard) in the environment within the field of view of the camera 294. Once the photographic image is acquired, the process proceeds to block 610.

In block 610, the intensity image or the photographic image is displayed on the display 297. In the display 297, the operator selects a feature in the environment, such as a corner of a wall or a reflective target for example. The operator then selects the same feature in the electronic model to define or associate that these locations as representing the same point in space. In an embodiment, the feature is natural feature and may be automatically detected in block 614 using a suitable image processing technique, such as but not limited to Canny, Solbel, Kayyali detectors or a Gaussian or Hessian type detector for example.

The method 600 then proceeds to query block 616 where it is determined whether additional points in the environment/model are desired. In the illustrated embodiment, it is desired to have four or more points identified in the environment/model. In other embodiments, it is desired to have at least six points identified in the environment/model. When the query block 616 returns a positive, the method 600 loops back to block 610 and additional points are identified in the image and the model.

It should be appreciated that in some embodiments there may not be a sufficient number of natural features (e.g. corners) to obtain a desired level of alignment. In one embodiment, when fewer natural features than are desired are within the field of view, the operator may create an artificial point in space using a device such as a plumb bob for example. The operator installs the plumb bob and measures using a tape measure from known locations to the point of the plumb bob. A corresponding point may then be added to the electronic model. In still other embodiments, an artifact having multiple retroreflective targets may be placed in the environment within the field of view of the image.

It should be appreciated that there may be a difference between an electronic design-model that was generated as part of the original design, and an as-built model. The as-built model will be generally more accurate regarding the position/location of features. As a result when a design-model is used, in some instances the alignment will deviate from a desired level of accuracy. In some embodiments, the movement or rotation data from the IMU 299 may be used to narrow the solution space so avoid or reduce the risk of an alignment that is incorrect. In other embodiments, one or more artifacts placed in the environment may provide an indication on whether the alignment is within desired accuracy parameters.

When the query block 616 returns a negative, meaning a sufficient number of features/points having been identified in the image and the model, the method 600 proceeds to block 618 where the light projector 10′ and the electronic model are aligned using the features/points identified in block 610. With the light projector 10′ and the electronic model aligned, the method 600 proceeds to block 620 where the path for emitting the light is determined and the template is projected onto a surface in the environment. In an embodiment, the features and points are aligned using a best fit methodology.

In some embodiments, during operation the alignment of the light projector 10′ to the electronic model will change or move, this is sometimes referred to as “drift.” Without being bound to any particular theory, it is believed that drift may be caused by galvanometers heating or from physical interaction between the light projector 10′ the operator (e.g. the light projector is accidentally bumped), or vibrations in the environment (e.g. on the surface the light projector is placed).

Referring to FIG. 7, an embodiment of a method 700 is shown for performing a periodic drift check. The method 700 starts in block 702 with the light projector 10′ and the electronic model being aligned, such as in the manner described with reference to FIG. 6. The method 700 then proceeds to block 704 where the template or image is projected onto a surface within the environment. Then on a periodic or aperiodic basis, or when requested by the operator, a drift check will be performed. The method 700 proceeds to block 706 where one or more retroreflective targets are placed in the environment within the field of view of the camera 294. The method then proceeds to block 708 where a photographic image of the one or more retroreflective targets are acquired. In some embodiments, the acquisition of the photographic image includes activating the light source 296.

With the photographic image acquired, the method 700 proceeds to block 710 where the retroreflective targets are identified. The method 700 then compares in block 712 the positions of the retroreflective targets in the photographic image with the expected position of the of the retroreflective targets. The method 700 proceeds to block 714 where it is determined if the deviation in the imaged position from the expected position is more than a predetermined threshold. When the query block 714 returns a negative the method 700 loops back to block 704.

When the query block 714 returns a positive, the method 700 proceeds to block 716 where the light projector 10′ is once again aligned with the electronic model, such as in the manner described herein above with respect to FIG. 6. With the light projector 10′ and electronic model re-aligned, the method 700 loops back to block 704 to continue projecting the image or template.

It should be appreciated that in some embodiments, the operator may desire to rotate the light projector 10′ on the stand or tripod that it is mounted, such as to project a template that was outside the initial field of view, or to project a new template for example. Referring to FIG. 8, an embodiment is shown of a method 800 for rotating the light projector 10′ and realigning the light projector 10′ with the electronic model.

The method 800 starts in block 802 where the light projector is aligned to the electronic model, such as in the manner described in reference to FIG. 6 for example. The method 800 then proceeds to block 804 where the template is projected on to a surface in the environment and an action related to the template (e.g. install rebar cage, studwall layout, formwork position, opening position verification, class issue visualization) is performed in block 806.

The operator the rotates the light projector 10′ on the stand or tripod and the amount of rotation is measured with the IMU 299. In an embodiment, the operator uses the viewfinder (displaying an image from the camera 294) while rotating the light projector 10′ to orient the light projector 10′ in the desired direction. The method 800 then proceeds to block 810 where the light projector 10′ is realigned with the electronic model based at least in part on the angle of rotation measured by the IMU 299. With the light projector 10′ realigned, the method 800 proceeds to block 812 where the new template is projected onto a surface within the field of view of the light projector 10′ in the rotated position.

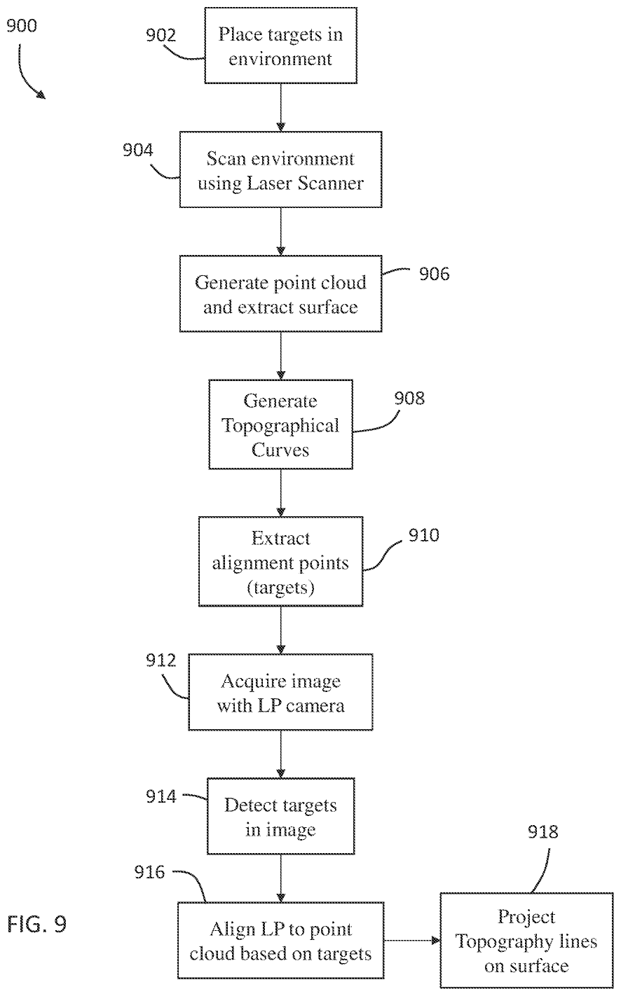

In some embodiments, it may be desirable to provide a visual indication of a floor or surface flatness. Referring now to FIG. 9, a method 900 is shown for measuring a flatness of a surface, generating topographical curves and projecting the topographical curves onto the surface with the light projector 10′. The method 900 starts in block 902 where targets (e.g. checkerboard targets) are placed in the environment. The method 900 then proceeds to block 904 where the environment is scanned with a laser scanner to measure three-dimensional (3D) coordinates of surfaces in the environment. In the illustrated embodiment, the laser scanner may be the same as that described in commonly owned U.S. Pat. No. 9,074,883 entitled “Device for optically scanning and measuring an environment” the contents of which are incorporated by reference herein.

The output of the laser scanner is a plurality of three-dimensional coordinates that represent points on the surfaces in the environment. These coordinates may be graphically represented as points, that are commonly referred to as a “point cloud.” The method generates the point cloud in block 906. From the point cloud, the user can identify and extract the surface to be analyzed (e.g. the floor). From this surface, topographical curves are generated in block 908. The curves may be based on a user defined resolution or zone size that defines the sampling distance on a grid. The user may further define the isometric height for the curves (e.g. 0.25 inches). In some embodiments, the user may also define an minimum island size that defines a size of the topographical contours.

The method 900 then proceeds to block 910 where the targets from block 902 are extracted as alignment points. The operator then acquires a photographic image of the environment with the camera 294. One or more of the targets from block 902 are located within the field of view of the camera 294. The method 900 then proceeds to block 914 where the targets are detected in the photographic image. Using the extracted alignment points from block 910 and the identified targets from block 194, the method 900 proceeds to block 916 where the light projector is aligned to the point cloud. The method 900 then proceeds to project a template based on the topographical curves of block 908 to provide a visual indication of the flatness of the surface.

It should be appreciated that while the embodiment of FIG. 9 refers to a floor, this is for exemplary purposes and the claims should not be so limited. In other embodiments, the surface being measured and projected onto may be a different surface, such as but not limited to a ceiling, a wall, or a column for example.

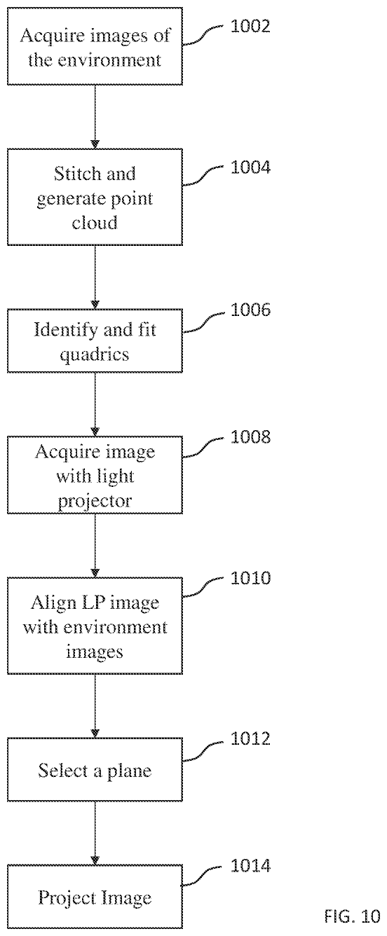

Referring now to FIG. 10, an embodiment is shown of another method 1000 for aligning the light projector 10 to the environment without using a pre-existing electronic model of the environment. In this embodiment, the method 1000 starts in block 1002 where the operator acquires a plurality of images of the environment where the light projector is to be operated. In an embodiment, the operator acquires the plurality of images in 360 degree range about the area where the light projector is to be placed. In another embodiment, the operator acquires a plurality of images in the area where the template is to be projected. In the illustrated embodiment, the plurality of images is acquired using a mobile computing device, such as a mobile phone for example.

The method 1000 then proceeds to block 1004 where the plurality of images is stitched together and used to generate a point cloud. The image stitching and point cloud generation may be performed using a known techniques, such as that provided by the FOVEX 360 software produced by Photocore AG of Schlieren, Switzerland for example. The image stitching and point cloud may be generated on the mobile computing device, a general computing device, or on a distributed computing platform (e.g. a cloud computing system).

Once the point cloud of the environment, or a portion thereof, is generated the method 1000 proceeds to block 1006 where quadratics (i.e. planes, cylinders, spheres) are identified and are fit to the point cloud. This step may also be referred to as fitting a mesh to the point cloud. In an embodiment, the mesh and quadratic locations are then transmitted to the mobile computing device or the light projector.

The method 1000 then proceeds to block 1008 where an image is acquired with the camera 294 on the light projector 10. In an embodiment, the operator moves and/or rotates the light projector 10 using the viewfinder functionality on the display 297 to orient the light projector towards the further where the template is to be projected. The method 1000 then proceeds to block 1010 where the light projector image acquired in block 1008 is aligned with the plurality of images acquired in block 1002. It should be appreciated that the alignment of the light projector image with the plurality of images allows for the alignment of the light projector 10 with the point cloud generated in block 1004 and also the quadratics generated in block 1006.

With the light projector and quadratics aligned, the method 1000 proceeds to block 1012 where the user selects a plane (e.g. one of the fitted quadratics). In an embodiment, the selection is via the display 297. In another embodiment the selection is performed via the mobile computing device that acquired the plurality of images in block 1002. In another embodiment, the display 297 is integral with the mobile computing device. With the plane selected, the method 1000 then proceeds to block 1014 where the template/projection is projected onto the surface. In an embodiment, the user may select the template/projection from a plurality of predetermined projections. The predetermined projections may include, but are not limited to, a line (pick two points), a parallel line (pick one point and a reference feature), a level line (pick one point, the IMU 299 is used for determining the reference plane), a grid (pick size and orientation), and a circle (pick location and size). It should be appreciated that in other embodiments, other predetermined projections may be provided.

It should be appreciated that while embodiments herein refer to the camera 294 as being integral with the light projector 10′, this is for exemplary purposes and the claims should not be so limited. In other embodiments, the camera 294 may be separate, but in a known geometric relationship, with the light projector 10′. Further, while the camera 294 may be referred to in the singular, in some embodiments multiple camera may be used.

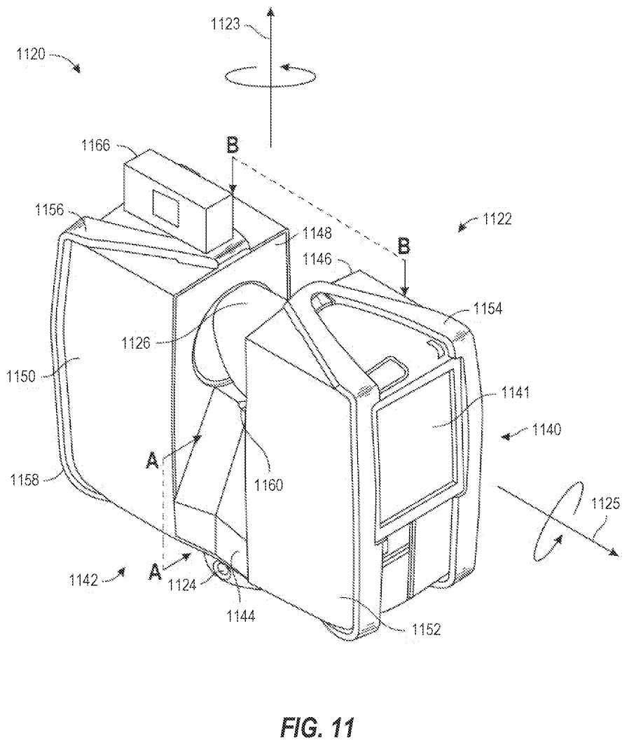

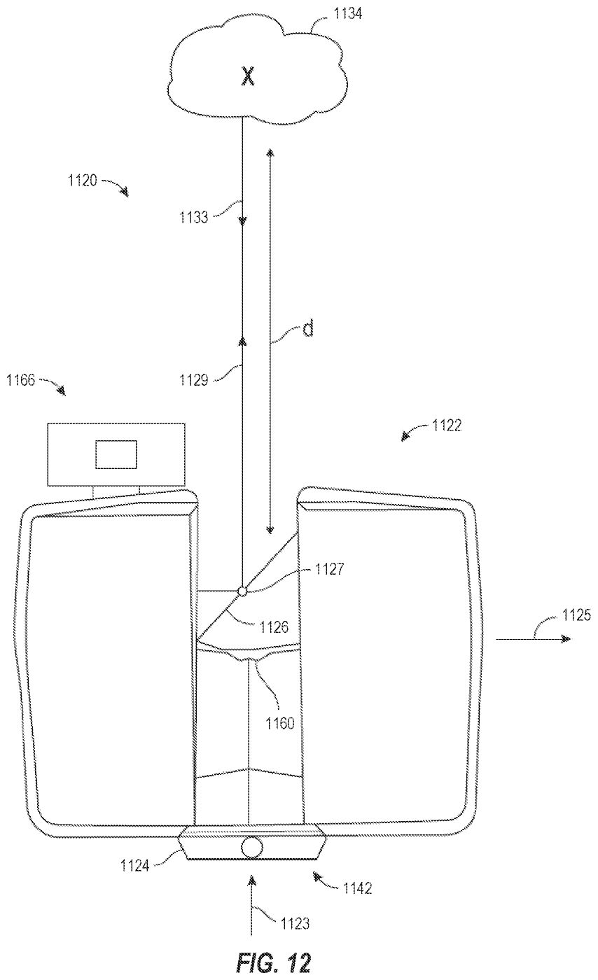

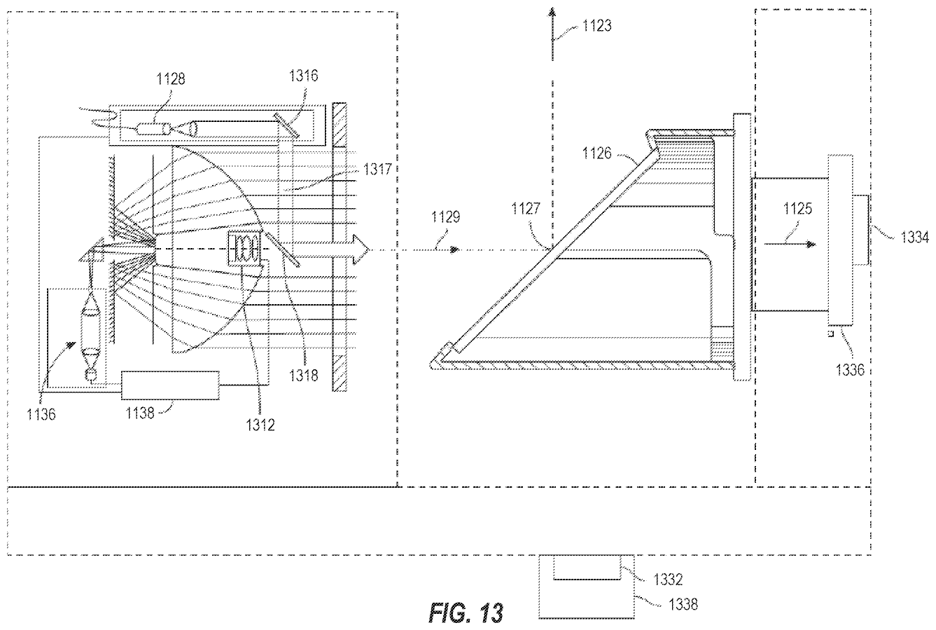

One or more embodiments of a 3D scanner used to capture a point cloud of the real-world environment are now described with reference to FIGS. 11-14.

Referring now to FIGS. 11-14, a laser scanner 1120 is shown for optically scanning and measuring the real-world environment surrounding the laser scanner 1120. It should be appreciated that while embodiments herein describe a phase-based time of flight scanner, this is for example purposes and the claims should not be so limited. In other embodiments, other types of three-dimensional (3D) coordinate measurement devices may be used to generate a point cloud. These 3D coordinate measurement devices include pulsed time of flight scanners, photogrammetry devices, laser line probes, triangulations scanners, area scanners, laser trackers, structured light scanners, and articulated arm coordinate measurement machines for example. The laser scanner 1120 has a measuring head 1122 and a base 1124. The measuring head 1122 is mounted on the base 1124 such that the laser scanner 1120 may be rotated about a vertical axis 1123. In one embodiment, the measuring head 1122 includes a gimbal point 1127 that is a center of rotation about the vertical axis 1123 and a horizontal axis 1125. The measuring head 1122 has a rotary mirror 1126, which may be rotated about the horizontal axis 1125. The rotation about the vertical axis may be about the center of the base 1124. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 1122 is further provided with an electromagnetic radiation emitter, such as light emitter 1128, for example, that emits an emitted light beam 1129. In one embodiment, the emitted light beam 1129 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 1129 is amplitude or intensity modulated, for example, with a sinusoidal waveform or with a rectangular waveform. The emitted light beam 1129 is emitted by the light emitter 1128 onto a beam steering unit, such as mirror 1126, where it is deflected to the real-world environment. A reflected light beam 1132 is reflected from the real-world environment by an object 1134. The reflected or scattered light is intercepted by the rotary mirror 1126 and directed into a light receiver 1136. The directions of the emitted light beam 1129 and the reflected light beam 1132 result from the angular positions of the rotary mirror 1126 and the measuring head 1122 about the axes 1125 and 1123, respectively. These angular positions in turn depend on the corresponding rotary drives or motors.

Coupled to the light emitter 1128 and the light receiver 1136 is a controller 1138. The controller 1138 determines, for a multitude of measuring points X, a corresponding number of distances d between the laser scanner 1120 and the points X on object 1134. The distance to a particular point X is determined based at least in part on the speed of light in air through which electromagnetic radiation propagates from the device to the object point X. In one embodiment the phase shift of modulation in light emitted by the laser scanner 1120 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cair=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 1120 takes place by rotating the rotary mirror 1126 relatively quickly about axis 1125 while rotating the measuring head 1122 relatively slowly about axis 1123, thereby, moving the assembly in a spiral pattern. In an exemplary embodiment, the rotary mirror rotates at a maximum speed of 5820 revolutions per minute. For such a scan, the gimbal point 1127 defines the origin of the local stationary reference system. The base 1124 rests in this local stationary reference system. In addition to measuring a distance d from the gimbal point 1127 to an object point X, the scanner 1120 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

In addition to measuring a distance d from the gimbal point 1127 to an object point X, the scanner 1120 may also collect gray-scale information related to the received optical power (equivalent to the term “brightness.”) The gray-scale value may be determined at least in part, for example, by integration of the bandpass-filtered and amplified signal in the light receiver 1136 over a measuring period attributed to the object point X.

The measuring head 1122 may include a display device 1140 integrated into the laser scanner 1120. The display device 1140 may include a graphical touch screen 1141, as shown in FIG. 5, which allows the operator to set the parameters or initiate the operation of the laser scanner 1120. For example, the screen 1141 may have a user interface that allows the operator to provide measurement instructions to the device, and the screen may also display measurement results.

The laser scanner 1120 includes a carrying structure 1142 that provides a frame for the measuring head 1122 and a platform for attaching the components of the laser scanner 1120. In one embodiment, the carrying structure 1142 is made from a metal such as aluminum. The carrying structure 1142 includes a traverse member 1144 having a pair of walls 1146, 1148 on opposing ends. The walls 1146, 1148 are parallel to each other and extend in a direction opposite the base 1124. Shells 1150, 1152 are coupled to the walls 1146, 1148 and cover the components of the laser scanner 1120. In the exemplary embodiment, the shells 1150, 1152 are made from a plastic material, such as polycarbonate or polyethylene for example. The shells 1150, 1152 cooperate with the walls 46, 48 to form a housing for the laser scanner 1120.

On an end of the shells 1150, 1152 opposite the walls 1146, 1148 a pair of yokes 1154, 1156 are arranged to partially cover the respective shells 1150, 1152. In the exemplary embodiment, the yokes 11154, 156 are made from a suitably durable material, such as aluminum for example, that assists in protecting the shells 1150, 1152 during transport and operation. The yokes 1154, 1156 each includes a first arm portion 1158 that is coupled, such as with a fastener for example, to the traverse 1144 adjacent the base 1124. The arm portion 1158 for each yoke 1154, 1156 extends from the traverse 44 obliquely to an outer corner of the respective shell 1150, 1152. From the outer corner of the shell, the yokes 1154, 1156 extend along the side edge of the shell to an opposite outer corner of the shell. Each yoke 1154, 1156 further includes a second arm portion that extends obliquely to the walls 1146, 1148. It should be appreciated that the yokes 54, 56 may be coupled to the traverse 1142, the walls 1146, 1148 and the shells 1150, 1152 at multiple locations.

The pair of yokes 1154, 1156 cooperate to circumscribe a convex space within which the two shells 1150, 1152 are arranged. In the exemplary embodiment, the yokes 1154, 1156 cooperate to cover all of the outer edges of the shells 1150, 1152, while the top and bottom arm portions project over at least a portion of the top and bottom edges of the shells 1150, 1152. This provides advantages in protecting the shells 1150, 1152 and the measuring head 1122 from damage during transportation and operation. In other embodiments, the yokes 1154, 1156 may include additional features, such as handles to facilitate the carrying of the laser scanner 1120 or attachment points for accessories for example.

On top of the traverse 1144, a prism 1160 is provided. The prism extends parallel to the walls 1146, 1148. In the exemplary embodiment, the prism 1160 is integrally formed as part of the carrying structure 1142. In other embodiments, the prism 1160 is a separate component that is coupled to the traverse 1144. When the mirror 1126 rotates, during each rotation the mirror 1126 directs the emitted light beam 1129 onto the traverse 1144 and the prism 1160. Due to non-linearities in the electronic components, for example in the light receiver 1136, the measured distances d may depend on signal strength, which may be measured in optical power entering the scanner or optical power entering optical detectors within the light receiver 1136, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 1136. Since the prism 1160 is at a known distance from the gimbal point 1127, the measured optical power level of light reflected by the prism 1160 may be used to correct distance measurements for other measured points, thereby allowing for compensation to correct for the effects of environmental variables such as temperature. In the exemplary embodiment, the resulting correction of distance is performed by the controller 1138.

In an embodiment, the base 1124 is coupled to a swivel assembly (not shown) such as that described in commonly owned U.S. Pat. No. 8,705,012 (′012), which is incorporated by reference herein. The swivel assembly is housed within the carrying structure 1142 and includes a motor 1338 that is configured to rotate the measuring head 1122 about the axis 1123. In an embodiment, the angular/rotational position of the measuring head 1122 about the axis 1123 is measured by angular encoder 1334.

An auxiliary image acquisition device 1166 may be a device that captures and measures a parameter associated with the scanned area or the scanned object and provides a signal representing the measured quantities over an image acquisition area. The auxiliary image acquisition device 1166 may be, but is not limited to, a pyrometer, a thermal imager, an ionizing radiation detector, or a millimeter-wave detector. In an embodiment, the auxiliary image acquisition device 1166 is a color camera.

In an embodiment, a central color camera (first image acquisition device) 1312 is located internally to the scanner and may have the same optical axis as the 3D scanner device. In this embodiment, the first image acquisition device 1312 is integrated into the measuring head 1122 and arranged to acquire images along the same optical pathway as emitted light beam 1129 and reflected light beam 1133. In this embodiment, the light from the light emitter 1128 reflects off a fixed mirror 1316 and travels to dichroic beam-splitter 1318 that reflects the light 1317 from the light emitter 1128 onto the rotary mirror 1126. In an embodiment, the mirror 1126 is rotated by a motor 1336 and the angular/rotational position of the mirror is measured by angular encoder 1334. The dichroic beam-splitter 1318 allows light to pass through at wavelengths different than the wavelength of light 1317. For example, the light emitter 1128 may be a near infrared laser light (for example, light at wavelengths of 780 nm or 1150 nm), with the dichroic beam-splitter 1318 configured to reflect the infrared laser light while allowing visible light (e.g., wavelengths of 400 to 700 nm) to transmit through. In other embodiments, the determination of whether the light passes through the beam-splitter 1318 or is reflected depends on the polarization of the light. The camera 1312 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 1123 and by steering the mirror 1126 about the axis 1125.

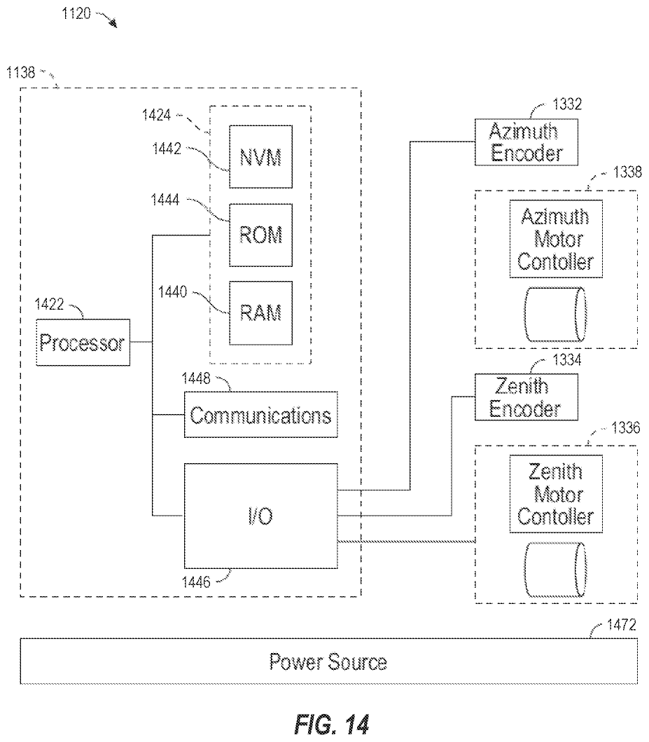

Referring now to FIG. 14 with continuing reference to FIGS. 11-13, elements are shown of the laser scanner 1120. Controller 1138 is a suitable electronic device capable of accepting data and instructions, executing the instructions to process the data, and presenting the results. The controller 1138 includes one or more processing elements 1422 (also referred to as “processors” or “processing devices”). The processors may be microprocessors, field programmable gate arrays (FPGAs), digital signal processors (DSPs), and generally any device capable of performing computing functions. The one or more processors 1422 have access to memory 1424 for storing information.

Controller 1138 is capable of converting the analog voltage or current level provided by light receiver 1136 into a digital signal to determine a distance from the laser scanner 1120 to an object in the real-world environment. Controller 1138 uses the digital signals that act as input to various processes for controlling the laser scanner 1120. The digital signals represent one or more laser scanner 1120 data including but not limited to distance to an object, images of the real-world environment, images acquired by a panoramic camera (not shown), angular/rotational measurements by a first or azimuth encoder 1332, and angular/rotational measurements by a second axis or zenith encoder 1334.

In general, controller 38 accepts data from encoders 1332, 1334, light receiver 1136, light emitter 1128, and the panoramic camera (not shown) and is given certain instructions for the purpose of generating a 3D point cloud of a scanned real-world environment. Controller 1138 provides operating signals to the light emitter 1128, light receiver 1136, the panoramic camera (not shown), zenith motor 1336 and azimuth motor 1338. The controller 1138 compares the operational parameters to predetermined variances and if the predetermined variance is exceeded, generates a signal that alerts an operator to a condition. The data received by the controller 1138 may be displayed on a user interface coupled to controller 1138. The user interface may be one or more LEDs (light-emitting diodes), an LCD (liquid-crystal diode) display, a CRT (cathode ray tube) display, a touch-screen display or the like. A keypad may also be coupled to the user interface for providing data input to controller 1138. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 1120.

The controller 1138 may also be coupled to external computer networks such as a local area network (LAN) and the Internet. A LAN interconnects one or more remote computers, which are configured to communicate with controller 1138 using a well-known computer communications protocol such as TCP/IP (Transmission Control Protocol/Internet(\hat{ })Protocol), RS-232, ModBus, and the like. Additional systems may also be connected to LAN with the controllers 1138 in each of these systems being configured to send and receive data to and from remote computers and other systems. The LAN may be connected to the Internet. This connection allows controller 1138 to communicate with one or more remote computers connected to the Internet.

The controller 1138 can be powered by a power source 1472, such as a battery or other suitable source of electric energy.

The processors 1422 are coupled to memory 1424. The memory 1424 may include random access memory (RAM) device 1440, a non-volatile memory (NVM) device 1442, and a read-only memory (ROM) device 1444. In addition, the processors 1422 may be connected to one or more input/output (I/O) controllers 1446 and a communications circuit 1448. In an embodiment, the communications circuit 1448 provides an interface that allows wireless or wired communication with one or more external devices or networks, such as the LAN discussed above.

Controller 1138 includes operation control methods embodied in computer instructions written to be executed by processors 1422, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

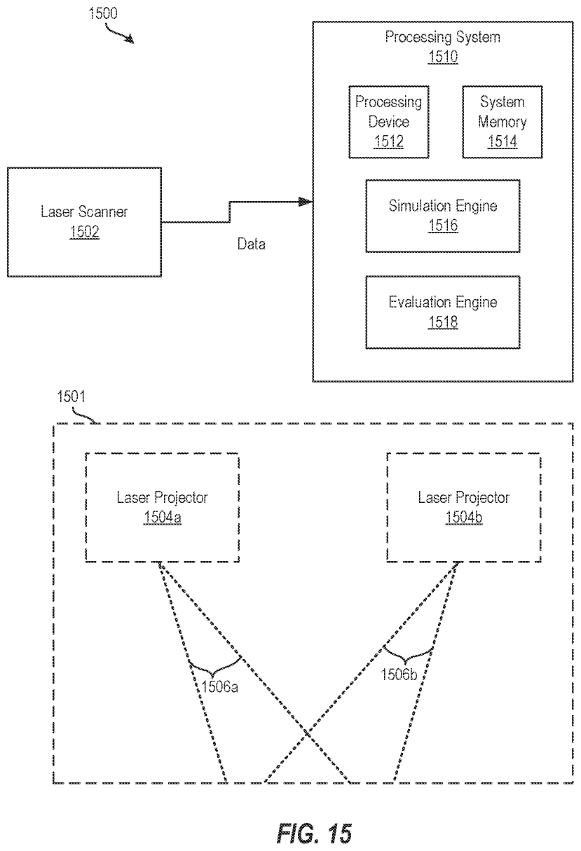

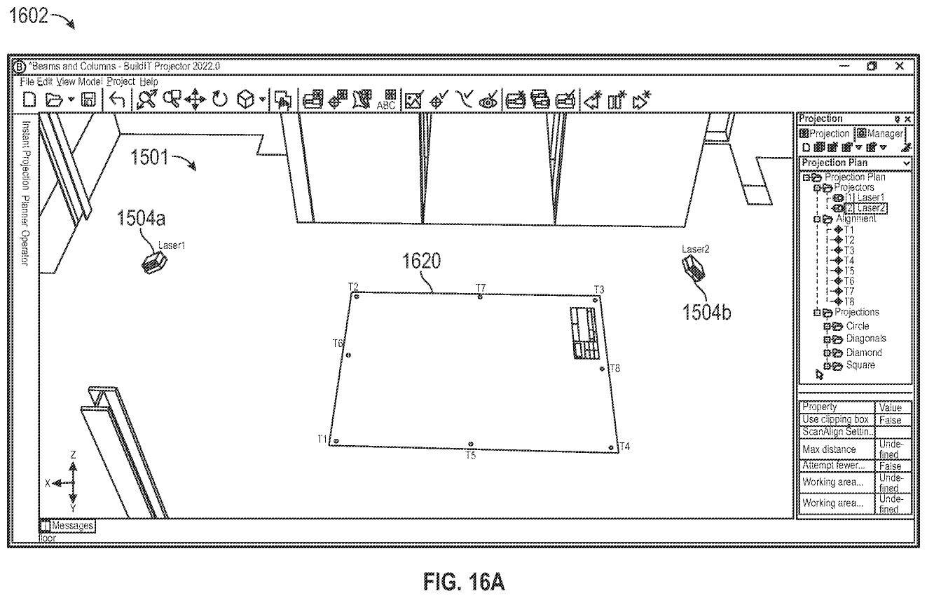

Turning now to FIG. 15, a system 1500 for simulating one or more laser projectors in a virtual environment 1501 is depicted according to one or more embodiments described herein. When it comes to setting up physical laser projectors, both coverage and accuracy can be considered, and multiple factors can be taken into account to achieve desired coverage and accuracy. The system 1500 enables simulating these factors to achieve the desired coverage and accuracy prior to placing the actual system in the environment. This provides for reduced or minimum changes to the position and/or orientation of physical laser scanners once implemented in a real-world environment.

The system 1500 includes a processing system 1510 for performing a simulation of one or more laser projectors (e.g., the laser projectors 1504a, 1504b (collectively “laser projectors 1504”). The processing system 1510 is communicatively connected to a laser scanner 1502 (e.g., the laser scanner 1120) for optically scanning and measuring a real-world environment surrounding the laser scanner 1120. As used herein, communicatively connected (or a communicative connection) means data can be communicated over the connection. For example, the laser scanner 1502 can transmit data, such as point cloud data or other 3D coordinate scan data, to the processing system 1510.

The virtual environment 1501 is a virtual representative of a real-world environment. The laser scanner 1502 (which can be any suitable scanner, such as the scanner 1120 of FIGS. 11-14) scans a real-world environment and collects data about the real-world environment. The processing system 1510 generates the virtual environment 1501 using data from the laser scanner 1502.

The processing system 1510 includes a processing device 1512, a system memory 1514, a simulation engine 1516, and an evaluation engine 1518. The features and functionality of the engines described herein can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the features and functionality of the simulation engine 1516 and the evaluation engine 1518 described herein can be a combination of hardware and programming. The programming can be processor executable instructions stored on a tangible memory, and the hardware can include the processing device 1512 for executing those instructions. Thus the system memory 1512 (e.g., random access memory, read-only memory, etc.) can store program instructions that when executed by the processing device 1512 implement the features and functionality of the simulation engine 1516 and the evaluation engine 1518. Other engines can also be utilized to include other features and functionality described in other examples herein.

According to one or more embodiments described herein the simulation engine 1516 uses the data collected by the laser scanner 1502 to simulation the laser projectors 1504 projecting into the virtual environment 1501. In other embodiments, the simulation engine 1516 could use point cloud data, a CAD model, and/or any other suitable source of data to simulate the laser projectors 1540 projecting into the virtual environment 1501. As shown, each of the laser projectors 1504 project a beam of light into the virtual environment 1501. For example, the simulation engine 1516 simulates the laser projector 1504a projecting a beam of light 1506a into the virtual environment 1501. Similarly, the simulation engine 1516 simulates the laser projector 1504b projecting a beam of light 1506b into the virtual environment 1501.

The evaluation engine 1518 evaluates the simulation to determine whether one or more projector preferences are satisfied. Examples of projection preferences are field of view preferences, overlap preferences, incident angle preferences, obstruction preferences, and the like.

A field of view preference could be that a particular area/region is within a field of view of a particular laser projector or combination of projectors. A laser projector that is too close to a surface or at a particular angle may not provide a desired field of view. Areas falling outside the field of view of a particular laser projector are shown in the simulation as not being projected. It may therefore be desirable to change the orientation and/or position of the laser scanner to achieve the desired field of view (e.g. a field of view that allows for a completed template to be projected on the surface).

An overlap preference could be to restrict a particular laser projector's field of view to reduce overlap between multiple laser projectors. For example, when running multiple projectors with overlapping fields of view, each projector can be limited to a user-specified box (i.e., clipping box) to reduce the overlap. If there is no overlap, then the projections from the multiple projectors that fall outside the clipping boxes for the projectors are shown in the simulation as not being projected. It may therefore be desirable to change the orientation and/or position of the laser scanner to achieve the desired overlap.

An incident angle (or “angle of incidence”) is the angle between a ray incident on a surface and the line perpendicular to the surface at the point of incidence. An incident angle preference could be that the incident angle does not satisfy an incident angle threshold. For example, to minimize the error caused by imperfect surfaces, projections can be clipped if they exceed the incident angle threshold. If a projection does not have a small enough incidence angle to any projector, then the projections are shown in the simulation as not being projected in the area where the incident angle threshold is not satisfied. It may therefore be desirable to change the orientation and/or position of the laser scanner to achieve the desired incident angle.

An obstruction preference (i.e., a setting) could be that the field of view of a laser projector is free from obstructions or that a threshold percentage of the field of view of the laser projector is free from obstructions (e.g., 99% free from obstructions). In some situations, a part or a tool can obstruct a projection; other times, features of the real-world environment (e.g., columns, beams, walls, etc.) can obstruct a projection. If none of the projectors is able to “see” an area of a region of interest, then the projections are shown in the simulation as not being projected in that area. It may therefore be desirable to change the orientation and/or position of the laser projector, for example to reduce or eliminate obstructions and/or otherwise improve the field of view of the laser projector.

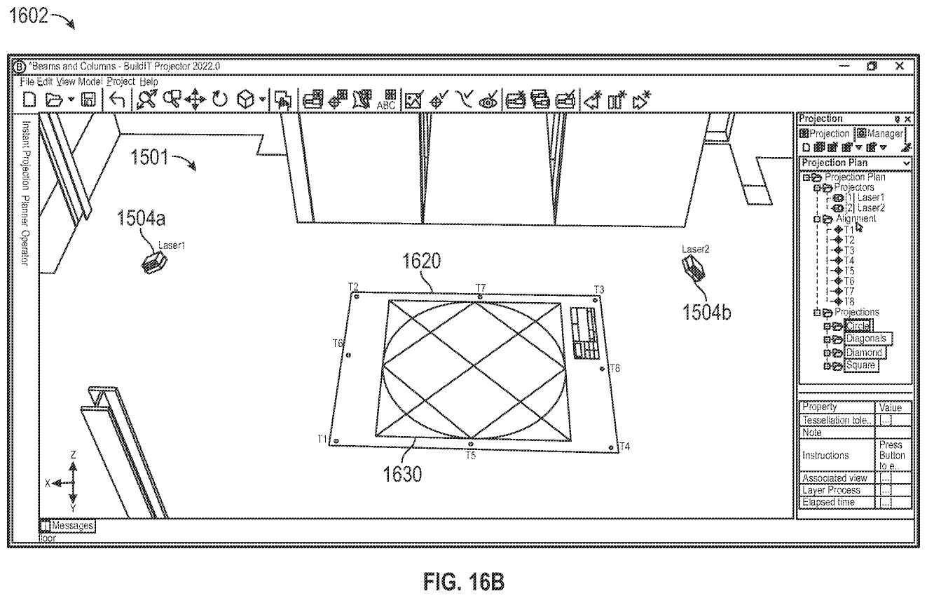

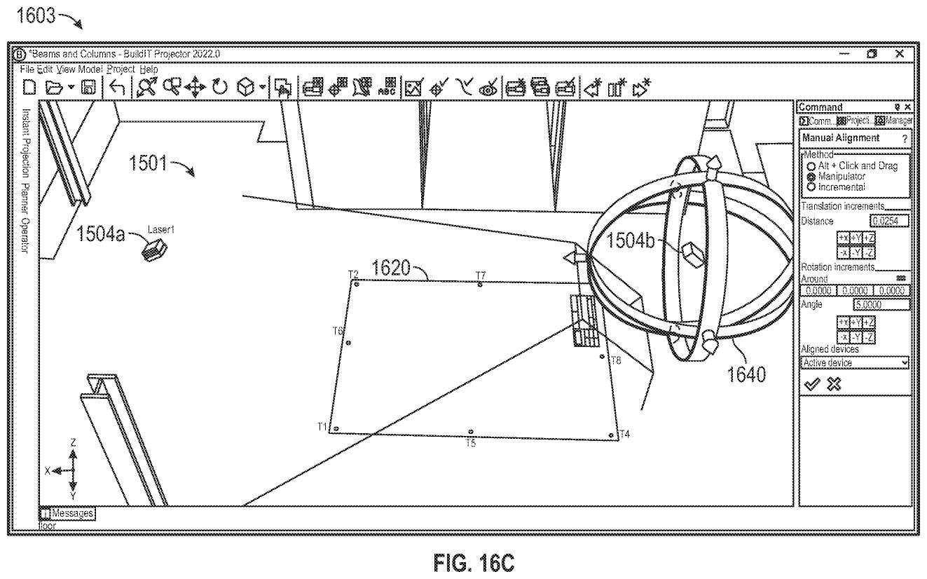

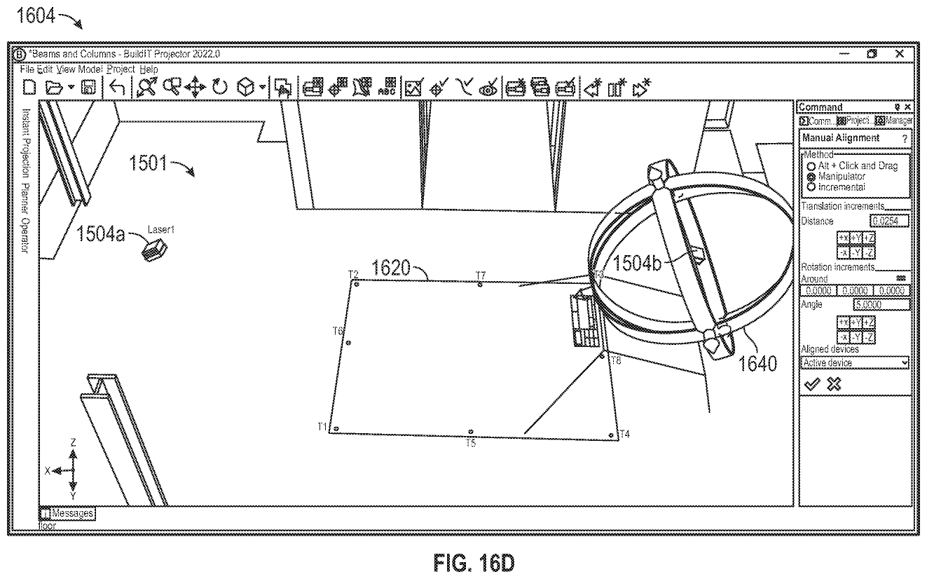

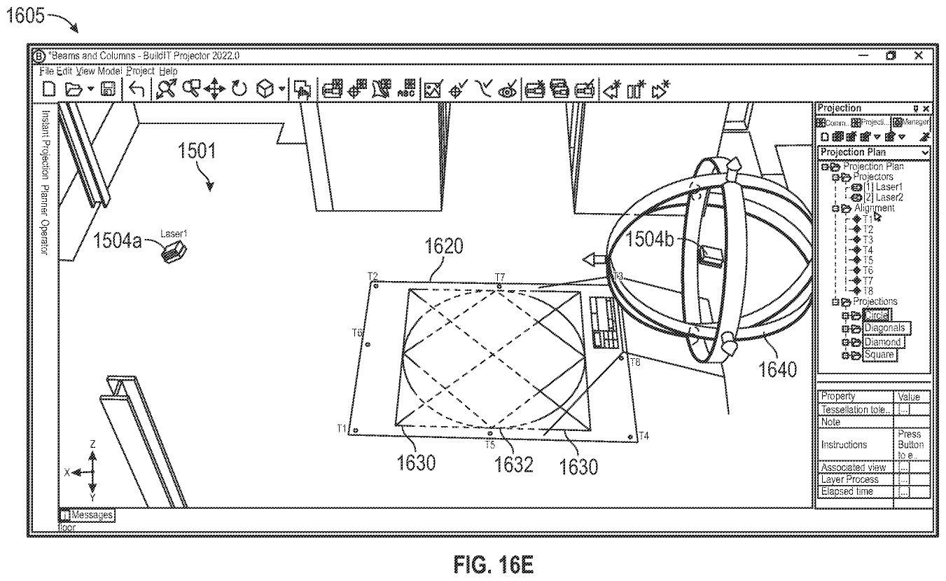

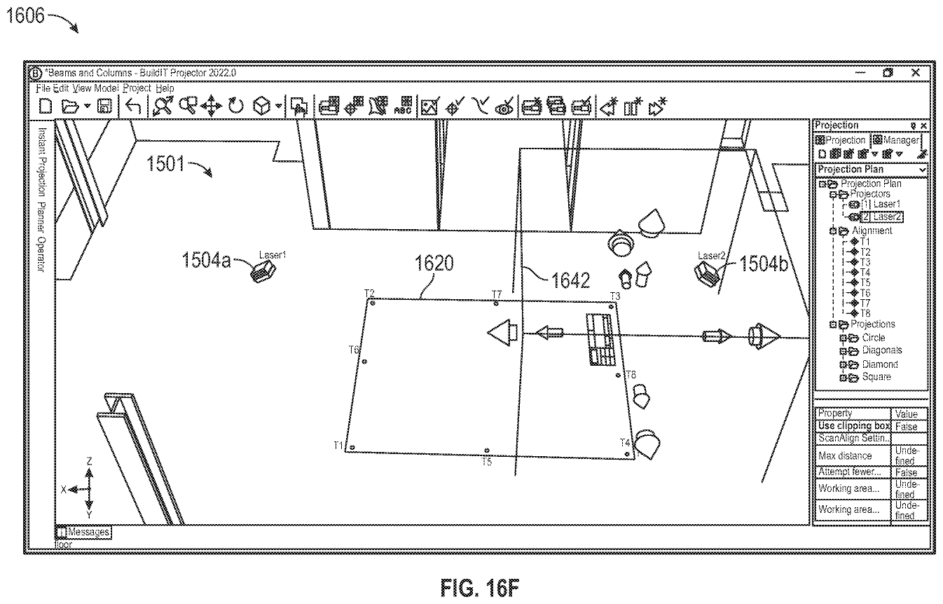

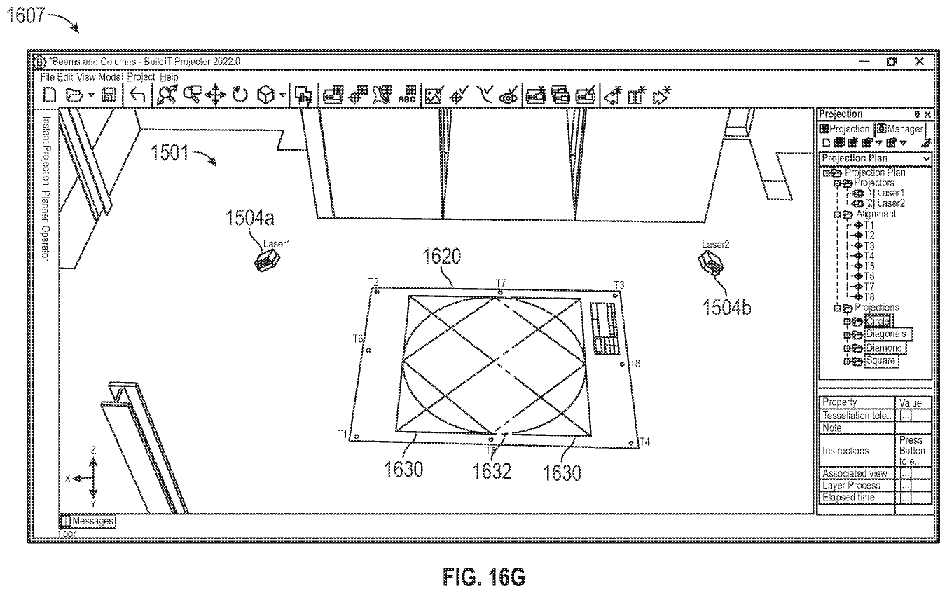

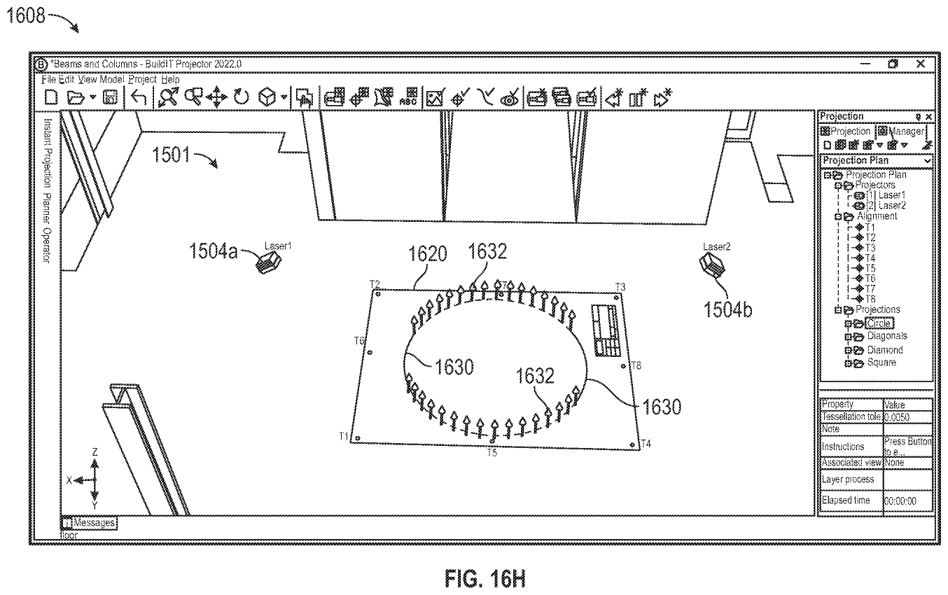

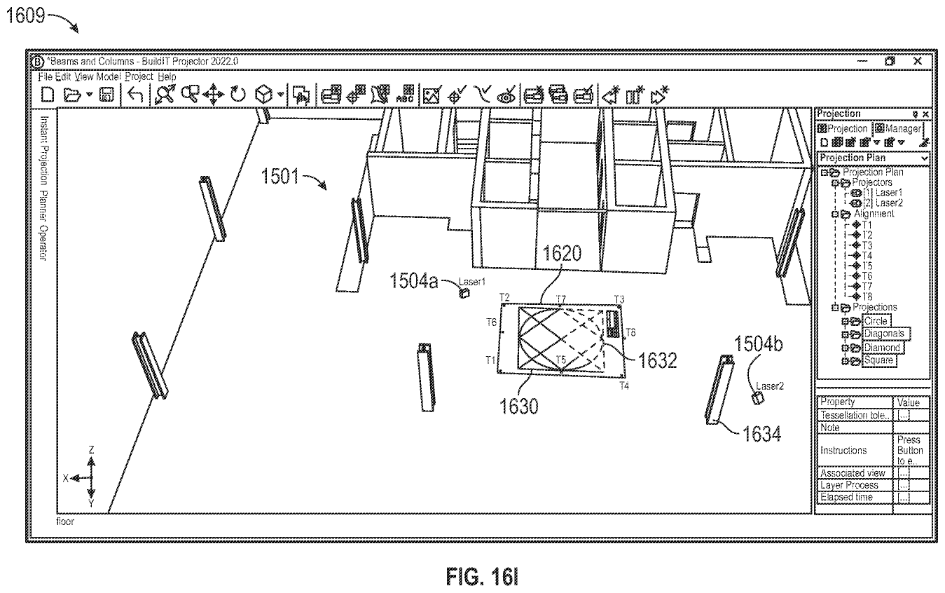

FIGS. 16A-16I depict example interfaces 1601-1609 of a simulation performed by the simulation engine 1516 according to one or more embodiments described herein. FIG. 16A depicts an interface 1601 of the virtual environment 1501 having the laser projectors 1504 represented therein. The virtual environment 1501 is generated based on data received from a laser scanner (e.g., the laser scanner 1502) (or other suitable device or source). The data represents a real-world environment and may be represented by a point cloud, CAD model, and/or other 3D representation (e.g., meshed surfaces generated from the point cloud). It should be appreciated that each of the laser projectors 1504 have a position and orientation (collectively referred to as a “pose”) associated therewith. The simulation engine 1516 provides for simulating projection of each of the laser projectors 1504 into the virtual environment (built from the point cloud received from the laser scanner 1502, for example) to evaluate the position and orientation of the laser projectors 1504. The simulation engine 1516 simulates the projectors 1504 projecting onto a region of interest 1620, which may be an assembly area for an object, for example.

The simulation engine 1516 provides for the simulation of different alignments of the laser projectors 1504 on the projection onto the region of interest 1620. For example, FIG. 16B depicts an 1602 showing a projection 1630 onto the region of interest 1620. A user of the processing system 1510 can select one of the laser projectors 1504 and simulate the alignment of that laser projector. For example, FIG. 16C depicts an interface showing a selection of the projector 1504b. The user can manipulate the position and/or orientation (e.g. the pose) of the laser projector 1504b using the user controls 1640 associated with the selected laser projector. Thus, the simulated position and/or orientation of the laser projector 1504b (and likewise the laser projector 1504a) can be adjusted. For example, if the laser projector 1504b is rotated as shown in FIG. 16D. If the new alignment is then applied and a simulation is performed, the projection 1630 onto the region of interest 1620 changes as shown in FIG. 16E. Particularly, in this example, a portion 1632 of the projection 1630 (shown by the dashed lines) is not projected. This is because the orientation and/or position of the laser projector 1504b was changed such that the portion 1632 falls outside the field of view of both laser projectors 1504a, 1504b. In such cases, it may be desirable to adjust a position of the laser projector 1504b (e.g., to physically move the laser projector 1504b within the environment) to adjust the projection.

The simulation engine 1516 also provides for setting a clipping box for a laser projector, such as the laser projector 1504b as shown in the interface 1606 of FIG. 16F to achieve a desired overlap. In this example, a clipping box 1642 is associated with the laser projector 1504b. A clipping box (not shown) can also be associated with the laser projector 1504a. In FIG. 16G, the interface 1607 shows the projection 1630 for clipping boxes associated with each of the laser projectors 1504. In this example, the projection 1630 includes the portion 1632 (shown by the dashed lines) that is not projected.

The simulation engine 1516 also provides for simulating the incident angle as shown in FIG. 16H. In this example, the projection 1630 is shown with the portion 1632 of the projection 1630 (shown by the arrows) falling outside the incident angle of the laser projectors 1504. This may indicate that an additional laser projector should be added to the real-world environment or that one or more of the laser projectors 1504 should be adjusted (e.g., adjust the position and/or orientation of one or more of the laser projectors 1504).

The simulation engine 1516 also provides for simulating how obstructions might affect the projection 1630. For example, as shown in FIG. 16I, an obstruction 1634 may interfere with the laser projector 1504b. When the projection 1630 is simulation, the portion 1632 (shown by the dashed lines) is not projected because it is obstructed by the obstruction 1634. Accordingly, the position and/or orientation of the laser projector 1504a can be adjusted to reduce or eliminate the portion 1632.

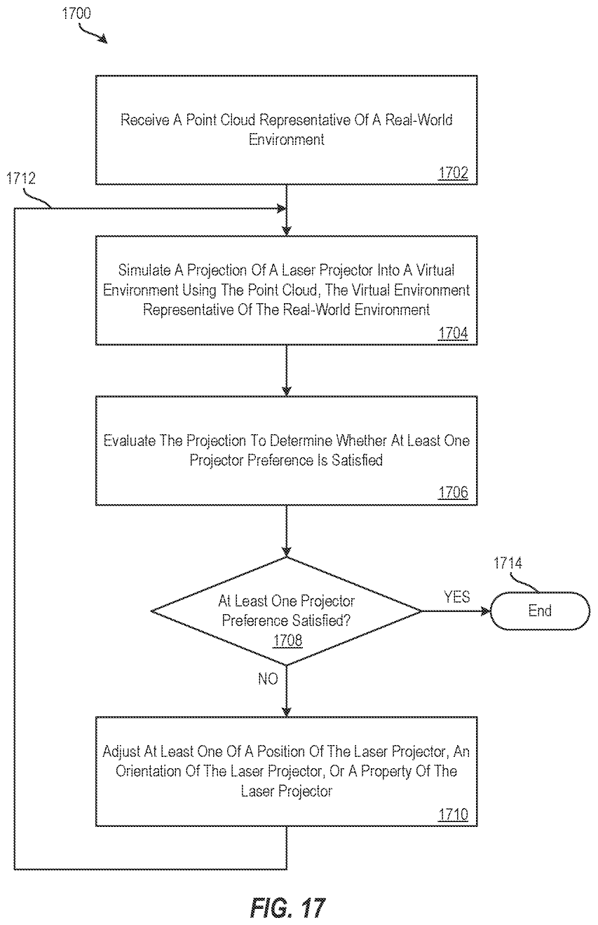

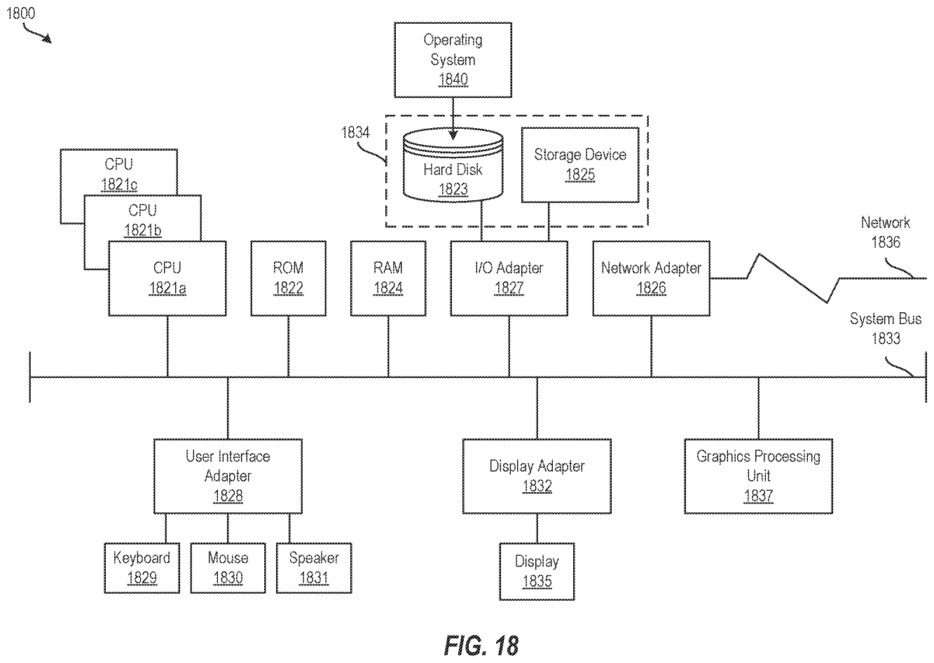

FIG. 17 depicts a flow diagram of a method 1700 for simulating one or more laser projectors in a virtual environment according to one or more embodiments described herein. The method 1700 can be performed by any suitable system or device, such as the processing system 1510 of FIG. 15, the processing system 1800 of FIG. 18, or the like, including combinations thereof.

At block 1702, the processing system 1510 receives a point cloud, CAD model, and/or the like representative of a real-world environment. For example, the laser scanner 1502 (e.g., the laser scanner 1120) scans a real-world environment and generates data about the real-world environment. The data can be used to construct the point cloud, which is a three-dimensional representation of the real-world environment. In other embodiments, the data may be used to generate a plurality of meshed surfaces representing the surfaces in the real-world environment. As described herein, the output of the laser scanner 1502 is a plurality of three-dimensional coordinates that represent points on the surfaces in the environment. These coordinates may be graphically represented as points, that are commonly referred to as a “point cloud.”

At block 1704, the processing system 1510 (e.g., using the simulation engine 1516) simulates a projection of a laser projector (e.g., one or more of the laser projectors 1504) into a virtual environment 1501 using the point cloud or meshed surfaces. The virtual environment 1501 is representative of the real-world environment. FIGS. 16A-16I depict interfaces of the simulation performed by the simulation engine 1516. According to one or more embodiments described herein, projections from multiple laser projectors can be simulated.

At block 1706, the processing system 1510 (e.g., using the evaluation engine 1518) evaluates the projection to determine whether at least one projector preference is satisfied. For example, the evaluation engine 1518 evaluates the different projection preferences (e.g., field of view preference, overlap preference, incident angle preference, obstruction preference, etc.).

At decision block 1708, the processing system 1510 (e.g., using the evaluation engine 1518) determines whether at least one projector preference is satisfied. Examples of projector preferences include a field of view preference, an overlap preference, an incident angle preference, an obstruction preference, etc. As an example, the evaluation engine 1518 may determine that a field of view preference of full coverage of a region of interest is not satisfied if at least a portion of the region of interest falls outside the field of view of both of the laser projectors 1504. As another example, the evaluation engine 1518 may determine that an incident angle preference is not satisfied if the incident angle fails to satisfy the incident angle threshold. As another example, the evaluation engine 1518 may determine that the obstruction is not satisfied if the field of view of a laser projector is not free from obstructions or that a threshold percentage of the field of view of the laser projector is not free from obstructions (e.g., 99% free from obstructions).

If, at decision block 1708, it is determined that the at least one projector preference is not satisfied, the position and/or the orientation of the laser projector is adjusted and/or a property of the laser projector (e.g., adjust a clipping box) is adjusted. For example, the laser projector 1504a and/or the laser projector 1504b can be moved within the virtual environment 1501 and/or an orientation of the laser projector 1504a and/or the laser projector 1504b can adjusted. The simulation at block 1704 can then be performed again as shown by the arrow 1712. The simulation (block 1704), evaluation (block 1706), determination (decision block 1708), and adjustment (block 1710) can continue iterative until it is determined that the at least one projector preference is satisfied at decision block 1708. Once it is determined that the at least one projector preference is satisfied at decision block 1708, the method 1700 can end at block 1714 or can proceed to another suitable step.

Additional processes also may be included, and it should be understood that the process depicted in FIG. 17 represents an illustration, and that other processes may be added or existing processes may be removed, modified, or rearranged without departing from the scope of the present disclosure.

One or more embodiments described herein improve the operation of laser projectors by simulating how the laser projectors operate so that the laser projectors can be improved, such as by adjusting their position, orientation, or properties associated therewith. By adjusting the position, orientation, or properties of a laser projector, the laser projector functions better than without such adjustments. For example, field of view, overlap, incident angle, and/or obstructions can be accounted for to improve the projections generated by the laser projectors.

It is understood that one or more embodiments described herein is capable of being implemented in conjunction with any other type of computing environment now known or later developed. For example, FIG. 18 depicts a block diagram of a processing system 1800 for implementing the techniques described herein. In accordance with one or more embodiments described herein, the processing system 1800 is an example of a cloud computing node of a cloud computing environment. In examples, processing system 1800 has one or more central processing units (“processors” or “processing resources”) 1821a, 1821b, 1821c, etc. (collectively or generically referred to as processor(s) 1821 and/or as processing device(s)). In aspects of the present disclosure, each processor 1821 can include a reduced instruction set computer (RISC) microprocessor. Processors 1821 are coupled to system memory (e.g., random access memory (RAM) 1824) and various other components via a system bus 1833. Read only memory (ROM) 1822 is coupled to system bus 1833 and may include a basic input/output system (BIOS), which controls certain basic functions of processing system 1800.

Further depicted are an input/output (I/O) adapter 1827 and a network adapter 1826 coupled to system bus 1833. I/O adapter 1827 may be a small computer system interface (SCSI) adapter that communicates with a hard disk 1823 and/or a storage device 1825 or any other similar component. I/O adapter 1827, hard disk 1823, and storage device 1825 are collectively referred to herein as mass storage 1834. Operating system 1840 for execution on processing system 1800 may be stored in mass storage 1834. The network adapter 1826 interconnects system bus 1833 with an outside network 1836 enabling processing system 1800 to communicate with other such systems.

A display (e.g., a display monitor) 1835 is connected to system bus 1833 by display adapter 1832, which may include a graphics adapter to improve the performance of graphics intensive applications and a video controller. In one aspect of the present disclosure, adapters 1826, 1827, and/or 1832 may be connected to one or more I/O busses that are connected to system bus 1833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1833 via user interface adapter 1828 and display adapter 1832. A keyboard 1829, mouse 1830, and speaker 1831 may be interconnected to system bus 1833 via user interface adapter 1828, which may include, for example, a Super I/O chip integrating multiple device adapters into a single integrated circuit.

In some aspects of the present disclosure, processing system 1800 includes a graphics processing unit 1837. Graphics processing unit 1837 is a specialized electronic circuit designed to manipulate and alter memory to accelerate the creation of images in a frame buffer intended for output to a display. In general, graphics processing unit 1837 is very efficient at manipulating computer graphics and image processing, and has a highly parallel structure that makes it more effective than general-purpose CPUs for algorithms where processing of large blocks of data is done in parallel.

Thus, as configured herein, processing system 1800 includes processing capability in the form of processors 1821, storage capability including system memory (e.g., RAM 1824), and mass storage 1834, input means such as keyboard 1829 and mouse 1830, and output capability including speaker 1831 and display 1835. In some aspects of the present disclosure, a portion of system memory (e.g., RAM 1824) and mass storage 1834 collectively store the operating system 1840 to coordinate the functions of the various components shown in processing system 1800.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method comprising:
receiving a point cloud representative of a real-world environment;
simulating a projection of a laser projector into a virtual environment based at least in part on the point cloud, the virtual environment representative of the real-world environment;
evaluating the projection to determine whether at least one projector preference is satisfied; and
responsive to determining that the at least one projector preference is not satisfied, adjusting at least one of a position of the laser projector, an orientation of the laser projector, or a property of the laser projector.

2. The method of claim 1, wherein receiving the point cloud representative of the real-world environment comprises scanning the real-world environment with a laser scanner to obtain a plurality of three-dimensional coordinates in the real-world environment.

3. The method of claim 1, wherein the at least one projector preference comprises a field of view preference.

4. The method of claim 1, wherein the at least one projector preference comprises an overlap preference.

5. The method of claim 1, wherein the at least one projector preference comprises an incident angle preference.

6. The method of claim 1, wherein the at least one projector preference comprises an obstruction preference.

7. The method of claim 1, wherein the laser projector is a first laser projector, and wherein simulating the projection comprises simulating the projection for the first laser projector and a second laser projector.

8. The method of claim 1, further comprising, subsequent to adjusting the at least one of the position or the orientation of the laser projector:
re-simulating the projection of the laser projector into the virtual environment that is based at least in part on the point cloud; and
re-evaluating the projection to determine whether the at least one projector preference is satisfied.

9. The method of claim 1, further comprising, prior to simulating the projection, aligning the point cloud to the real-world environment.

10. The method of claim 1, further comprising disposing the laser projector in the real-world environment based at least in part on the simulation.

11. A system comprising:
a memory comprising computer readable instructions; and
a processing device for executing the computer readable instructions, the computer readable instructions controlling the processing device to perform operations comprising:
receiving a point cloud representative of a real-world environment;
simulating a projection of a laser projector into a virtual environment based at least in part on the point cloud, the virtual environment representative of the real-world environment;
evaluating the projection to determine whether at least one projector preference is satisfied; and
responsive to determining that the at least one projector preference is not satisfied, adjusting at least one of a position of the laser projector, an orientation of the laser projector, or a property of the laser projector.

12. The system of claim 11, wherein receiving the point cloud representative of the real-world environment comprises scanning the real-world environment with a laser scanner to obtain a plurality of three-dimensional coordinates in the real-world environment.

13. The system of claim 11, wherein the at least one projector preference comprises a field of view preference.

14. The system of claim 11, wherein the at least one projector preference comprises an overlap preference.

15. The system of claim 11, wherein the at least one projector preference comprises an incident angle preference.

16. The system of claim 11, wherein the at least one projector preference comprises an obstruction preference.

17. The system of claim 11, wherein the laser projector is a first laser projector, and wherein simulating the projection comprises simulating the projection for the first laser projector and a second laser projector.

18. The system of claim 11, wherein the operations further comprise, subsequent to adjusting the at least one of the position or the orientation of the laser projector:
re-simulating the projection of the laser projector into the virtual environment that is based at least in part on the point cloud; and
re-evaluating the projection to determine whether the at least one projector preference is satisfied.

19. The system of claim 11, wherein the operations further comprise, prior to simulating the projection, aligning the point cloud to the real-world environment.

20. The system of claim 11, wherein the operations further comprise disposing the laser projector in the real-world environment based at least in part on the simulation.
